(19) United States
(12) Patent Application Publication
(10) Pub. No.: US 2009/0035591 A1
(43) Pub. Date: Feb. 5, 2009

(54) FLEXIBLE LAMINATE HAVING THERMOPLASTIC POLYIMIDE LAYER AND METHOD FOR MANUFACTURING THE SAME

(75) Inventors: Takahiro NISHIKAWA, Neyagawa-shi (JP); Masashi Nakano, Osaka (JP); Noriyuki Akane, Neyagawa-shi (JP); Nobuhito Ito, Hiki-gun (JP); Masaki Sasaki, Hiki-gun (JP); Masao Arima, Hiki-gun (JP)

Correspondence Address: OBLON, SPIVAK, MCCLELLAND MAIER & NEUSTADT, P.C., 1940 DUKE STREET, ALEXANDRIA, VA, 22314, US

(73) Assignees: KURASHIKI BOSEKI KABUSHIKI KAISHA, Okayama (JP); TAIYO INK MFG. CO., LTD., Nerima-ku (JP)

(21) Appl. No.: 12/242,250

(22) Filed: Sep. 30, 2008

Related U.S. Application Data
(63) Continuation of application No. PCT/JP2007/056218, filed on Mar. 26, 2007.

(30) Foreign Application Priority Data
Mar. 31, 2006 (JP) 2006-099282
Feb. 1, 2007 (JP) 2007-022776

(51) Int. Cl. B32B 15/088

(52) U.S. Cl. 428/458; 156/308.2

(57) ABSTRACT

In a flexible laminate containing a metal foil layer/a thermoplastic polyimide layer or/and a conductor circuit layer/a thermoplastic polyimide layer, the metal foil layer or the conductor circuit layer is bonded to at least one side of the thermoplastic polyimide layer. The thermoplastic polyimide layer is formed from a thermoplastic polyimide resin film or sheet produced by melt extrusion of a thermoplastic polyimide resin. Alternatively, the thermoplastic polyimide layer is formed from a biaxially oriented thermoplastic polyimide resin film or sheet. Such a flexible laminate can be easily manufactured by a lamination method which comprises bonding a thermoplastic polyimide resin film (1) to a metal foil (2) or a conductive circuit layer (4) by heating under pressure, and has excellent heat resistance, electrical properties and mechanical strength inherent in a polyimide. When the biaxially oriented thermoplastic polyimide resin film or sheet is used, the flexible laminate can be improved in dimensional stability and resistance to soldering heat.

### CROSS-REFERENCE TO RELATED APPLICATIONS

This is a continuation of Application PCT/JP2007/056218, filed Mar. 26, 2007, which was published under PCT Article 21(2).

### BACKGROUND OF THE INVENTION

1. Field of the Invention

This invention relates to a flexible laminate having a thermoplastic polyimide layer as an adhesive layer and a method for manufacturing the same.

2. Description of the Prior Art

In recent years, in view of high densification of the printed circuit boards in electronic devices, the printed circuit boards used therein are advanced toward the multi-layer construction and the flexible circuit boards of the multi-layer structure are widely used.

Since a polyimide resin film is enrich in flexibility, is soft and also excels in various characteristics, such as the mechanical strength, heat resistance, and electrical properties, it has been heretofore widely used as a three-layer board containing copper foils laminated thereon by the use of an adhesive, such as an epoxy resin, for the manufacture of a flexible printed circuit board and a tape-automated-bonding (TAB) product which can be said to be a kind of a flexible printed circuit board. However, since an adhesive is used, there are such problems that its dielectric constant becomes high and heat resistance becomes low.

In view of the increased demand for downsizing of the electrical and electronic equipment in recent years, the flexible printed circuit board is required to be further thinner and to be miniaturized so as to be arranged in a narrow space. Further, from a viewpoint of improvement in wiring density and folding endurance, the two-layer board having a copper layer directly formed on the surface of a polyimide resin film without using an adhesive layer has been supplied.

However, since a thermosetting polyimide film does not melt by heating, it cannot be directly laminated on a copper layer. Therefore, as a method for making a two-layer board by forming a copper layer on the surface of the polyimide resin film without using an adhesive, a vacuum deposition process, a casting method, and a plating method have been heretofore used widely. However, every method has drawbacks. Specifically, in the two-layer board having a copper layer formed on the surface of a polyimide resin film by the use of the vacuum deposition process, it poses such problems as poor adhesion of the copper layer to the polyimide resin film and low resistance to migration. On the other hand, since the casting method requires the steps of applying a polyamic acid which is a precursor of polyimide onto a copper foil and imidizing the polyamic acid at an elevated temperature, it has such drawbacks that the impurities may be easily intermingled with the material and the voids and such defective curling as warp of the produced board may easily occur, besides the complicated production steps and inferior productivity. Accordingly, it is also difficult to put this method in practical use.

Accordingly, the plating method is most commonly used. Generally used is a method of using an electroless plating process or a method of using an electroless plating process and an electroplating process in combination. However, these methods pose such problems that a copper layer formed by electroless copper plating also exhibits insufficient adhesion to a polyimide resin film, the peel strength (tearing off strength) of the copper layer is low, and thus the obtained board is inferior in reliability.

Further, another drawback common to all methods mentioned above is the fact that the laminating on a conductor layer can be performed only one side by one side, and a plurality of working steps are needed for laminating on both sides.

Further, the use of a thermoplastic polyimide is also proposed in many patent literatures (refer to JP 8-244168A, JP 2001-342270A, JP 2002-363284A, JP 2003-192789A, JP 2003-251773A, JP 2005-96265A, JP 2005-144908A, and JP 2005-193541A). However, the conventional polyimide is not suitable for melt fabrication even if it is thermoplastic. Therefore, the above patent literatures propose such a laminating method that a polyamic acid of a precursor is cast on a base film to apply thereon and then heated to cause an imidization reaction (dehydrating condensation reaction), thereby giving rise to a film, and the obtained film is laminated on a metal foil by the use of an adhesive, such as an epoxy resin. Accordingly, such a method also poses the problems that a dielectric constant becomes high due to the use of an adhesive as mentioned above and the heat resistance becomes low.

### SUMMARY OF THE INVENTION

The present invention has been made to solve the above-mentioned problems of the conventional technology and has a main object to provide a flexible laminate containing a metal foil layer/a thermoplastic polyimide layer or/and a conductor circuit layer/a thermoplastic polyimide layer, which can be easily manufactured by a laminating method and has such characteristics inherent in polyimide as excellent heat resistance, electrical properties, and mechanical strength.

A further object of the present invention is to provide a flexible laminate containing a metal foil layer/a thermoplastic polyimide layer or/and a conductor circuit layer/a thermoplastic polyimide layer, which can be easily manufactured by a laminating method and excels in various properties such as dimensional stability and resistance to soldering heat besides such characteristics inherent in polyimide as excellent heat resistance, electrical properties, and mechanical strength.

Another object of the present invention is to provide a method which is capable of laminating a polyimide layer on a conductor layer (a metal foil) by heating a thermoplastic polyimide resin film under pressure and thus manufacturing the above-mentioned flexible laminate with high productivity at a low cost by the laminating method without using an adhesive.

A still further object of the present invention is to provide a method which is capable of manufacturing the flexible laminate excelling in various properties, such as dimensional stability and resistance to soldering heat, with high productivity at a low cost by the laminating method without using an adhesive.

To accomplish the objects mentioned above, the present invention provides a flexible laminate containing a metal foil layer/a thermoplastic polyimide layer or/and a conductor circuit layer/a thermoplastic polyimide layer, wherein the metal foil layer or the conductor circuit layer is bonded to at least one side of the thermoplastic polyimide layer, characterized in that the above-mentioned thermoplastic polyimide layer is formed from a thermoplastic polyimide resin film or sheet (hereinafter referred to generically as “a thermoplastic polyimide resin film”) produced by melt extrusion of a thermoplastic polyimide resin or formed from a biaxially oriented thermoplastic polyimide resin film or sheet (hereinafter referred to generically as “a biaxially oriented thermoplastic polyimide resin film”).

In a preferred embodiment, the thermoplastic polyimide resin mentioned above is preferred to have a glass transition temperature (Tg) of 180-280° C. or a melt viscosity of 5×10¹-1×10⁴ [Pa·S] measured at a shear rate in the range of 50-500 [sec⁻¹] at an extrusion temperature higher than the melting point of the above-mentioned resin by 30° C. Here, although the melt viscosity [Pa·S] of the thermoplastic polyimide resin is a value measured using a flow tester CFT-500 manufactured by Shimadzu Corporation according to JIS (Japanese Industrial Standard) K-7199, it is not limited to this value and any value measured under the same conditions may be adopted.

Although the biaxially oriented thermoplastic polyimide resin film mentioned above may be obtained by biaxially stretching a thermoplastic polyimide resin film obtained by the casting method as in the conventional method, in a more preferred embodiment the biaxially oriented thermoplastic polyimide resin film is formed by biaxially stretching a thermoplastic polyimide resin film obtained by melt extrusion of a thermoplastic polyimide resin as described above. Preferably, the above-mentioned biaxially oriented thermoplastic polyimide resin film has a coefficient of thermal expansion, α₂₀₋₂₀₀, falling in the range of 5×10⁻⁶-30×10⁻⁶/K in any of a MD direction (longitudinal direction of the film) and a TD direction (width direction of the film). It is desirable that the difference in the coefficient of thermal expansion, α₂₀₋₂₀₀, between the MD direction (longitudinal direction of the film) and the TD direction (width direction of the film) should be less than 20×10⁻⁶/K. More preferably, it is desirable that a glass transition temperature Tg of the above-mentioned biaxially oriented thermoplastic polyimide resin film is higher than a glass transition temperature Tg of the unoriented thermoplastic polyimide resin film by 10-80° C. Incidentally, the glass transition temperature Tg as used in this specification is the glass transition temperature measured by the thermomechanical analysis (TMA) according to the method specified in “5.17.1 TMA method” of JIS C 6481:1996.

In another preferred embodiment, the above-mentioned thermoplastic polyimide resin is a crystalline thermoplastic polyimide resin or a mixture of a crystalline thermoplastic polyimide resin with other thermoplastic resin having a melting point of 280-350° C.

In a more concrete preferred embodiment, the above-mentioned thermoplastic polyimide resin is a thermoplastic polyimide resin having a recurring structural unit represented by the general formula (1) to be described hereinafter, preferably a recurring structural unit represented by the general formula (5) to be described hereinafter. More preferably, the above-mentioned thermoplastic polyimide resin is a thermoplastic polyimide resin containing the recurring structural units represented by the formulas (6) and (7) to be described hereinafter in such a proportion that the ratio m/n of the molar number “m” of the structural unit of formula (6) to the molar number “n” of the structural unit of formula (7) falls in the range of 4-9. In another preferred embodiment, the above-mentioned thermoplastic polyimide resin is a thermoplastic polyimide resin containing the recurring structural units represented by the formulas (6) and (8) to be described hereinafter in such a proportion that the molar ratio of the recurring structural unit represented by the formula (6) to the recurring structural unit represented by the formula (8) falls in the range of 1:0 to 0.75:0.25.

According to the present invention, there is further provided a method for manufacturing a flexible laminate. The fundamental embodiment is a method for manufacturing a flexible laminate containing a metal foil layer/a thermoplastic polyimide layer or/and a conductor circuit layer/a thermoplastic polyimide layer wherein the metal foil or conductor circuit layer is bonded to at least one side of the thermoplastic polyimide layer, characterized in that a thermoplastic polyimide resin film obtained by melt extrusion of a thermoplastic polyimide resin or a biaxially oriented thermoplastic polyimide resin film is bonded to the metal foil or the conductor circuit layer by heating under pressure.

A preferred embodiment of the method of the present invention for manufacturing a flexible laminate is characterized by preparing copper foils of which at least one side has been subjected to a surface roughening treatment or an adhesion modification treatment, superposing a thermoplastic polyimide resin film obtained by melt extrusion of a thermoplastic polyimide resin or a biaxially oriented thermoplastic polyimide resin film on the treated side of the copper foil, superposing the other copper foil on the opposite side of the film mentioned above so that the treated side of the copper foil is brought into contact with the film, and heating them under pressure.

Another preferred embodiment of the method of the present invention for manufacturing a flexible laminate is characterized by superposing thermoplastic polyimide resin films obtained by melt extrusion of a thermoplastic polyimide resin or biaxially oriented thermoplastic polyimide resin films on both sides of a polyimide resin film of which both sides have not been subjected to any surface treatment or have been subjected to an adhesion modification treatment, further superposing copper foils of which at least one side has been subjected to a surface roughening treatment or an adhesion modification treatment on the outer opposite sides of the films in such a manner that the treated surface of each copper foil faces inward, and heating them under pressure.

Still another preferred embodiment of the method of the present invention for manufacturing a flexible laminate is characterized by sandwiching a thermoplastic polyimide resin film obtained by melt extrusion of a thermoplastic polyimide resin or a biaxially oriented thermoplastic polyimide resin film between double-sided flexible boards having circuits formed on both sides thereof which have not been subjected to any surface treatment or have been subjected to an adhesion modification treatment, and heating them under pressure.

Yet another preferred embodiment of the method of the present invention for manufacturing a flexible laminate is characterized by superposing thermoplastic polyimide resin films obtained by melt extrusion of a thermoplastic polyimide resin or biaxially oriented thermoplastic polyimide resin films on the outer opposite sides of a double-sided flexible board, respectively, which board has circuits formed on both sides thereof and has not been subjected to any surface treatment or has been subjected to an adhesion modification treatment, further superposing copper foils of which at least one side has been subjected to a surface roughening treatment or an adhesion modification treatment on the outer opposite sides of the films in such a manner that the treated surface of each foil faces inward, and heating them under pressure.

In either embodiment mentioned above of the method of the present invention for manufacturing a flexible laminate, the use of the thermoplastic polyimide resin film or the biaxially oriented thermoplastic polyimide resin film of which one side or both sides have been subjected to a surface modification treatment is preferable. In a more preferred embodiment, the above-mentioned heating under pressure is performed at a temperature higher than the glass transition temperature Tg of the thermoplastic polyimide resin used, preferably higher than the glass transition temperature Tg and lower than the melting point of the thermoplastic polyimide resin film used or of the biaxially oriented thermoplastic polyimide resin film used. More preferably, the above-mentioned heating under pressure is performed at a temperature in the range of 300-380° C. Still more preferably, at the time of the above-mentioned heating under pressure, a felt-like cushioning material, preferably a felt-like cushioning material made of an aromatic polyamide or polybenzoxazol, is interposed between a press plate which is arranged in contact with a material to be heated under application of pressure and a pressing platen of a pressing machine.

The flexible laminate of the present invention contains a metal foil layer/a thermoplastic polyimide layer or/and a conductor circuit layer/a thermoplastic polyimide layer, wherein the metal foil layer or the conductor circuit layer is bonded to at least one side of the thermoplastic polyimide layer. In accordance with one embodiment, since the above-mentioned thermoplastic polyimide layer is formed from a thermoplastic polyimide resin film obtained by melt extrusion of a thermoplastic polyimide resin, it is possible to use a high-purity thermoplastic polyimide resin film which does not containing such impurities as a monomer residue and a residual solvent. Accordingly, it is possible to provide a flexible laminate containing the metal foil layer/the thermoplastic polyimide layer or/and the conductor circuit layer/the thermoplastic polyimide layer, which excels in the bond strength between the thermoplastic polyimide layer and the metal foil layer or/and conductor circuit layer and in resistance to migration, and has such properties inherent in polyimide as the excellent heat resistance, electrical properties, and mechanical strength.

In other embodiment, the thermoplastic polyimide layer is formed from a biaxially oriented thermoplastic polyimide resin film which exhibits few or small difference in the coefficient of thermal expansion between this film and the metal foil to be laminated therewith. Accordingly, it is possible to provide a flexible laminate containing the metal foil layer/the thermoplastic polyimide layer or/and the conductor circuit layer/the thermoplastic polyimide layer, which excels in the bond strength between the thermoplastic polyimide layer and the metal foil layer or/and conductor circuit layer and in resistance to migration, and excels in various properties such as the dimensional stability and resistance to soldering heat, besides such properties inherent in polyimide as the excellent heat resistance, electrical properties, and mechanical strength. Particularly, when the above-mentioned thermoplastic polyimide layer is formed from a biaxially oriented thermoplastic polyimide resin film which is obtained by biaxially stretching a thermoplastic polyimide resin film obtained by melt extrusion of the crystalline thermoplastic polyimide resin, it is possible to manufacture a high-purity thermoplastic polyimide resin film which does not contain such impurities as a monomer residue and a residual solvent, as described above. Further, since it is possible to easily manufacture the biaxially oriented thermoplastic polyimide resin film having the coefficient of thermal expansion, α₂₀₋₂₀₀, (hereinafter referred to briefly as “thermal expansion coefficient”) falling in the range of 5×10⁻⁶-30×10⁻⁶/K (hereinafter abbreviated as “ppm/K”) in any of the MD direction and the TD direction and exhibiting the difference in the thermal expansion coefficient between the MD direction and the TD direction of less than 20 ppm/K, the warp occurring at the time of laminating it on a metal foil may be effectively prevented. Furthermore, by biaxially stretching a thermoplastic polyimide resin film, it is possible to make its glass transition temperature Tg higher than the glass transition temperature Tg of an unoriented thermoplastic polyimide resin film by 10-80° C., thereby improving its resistance to soldering heat.

Since the method of the present invention for manufacturing the flexible laminate is the so-called lamination method, i.e the method of bonding the thermoplastic polyimide resin film obtained by melt extrusion of a thermoplastic polyimide resin or the biaxially oriented thermoplastic polyimide resin film onto a metal foil or a conductor circuit layer by heating under pressure to obtain the flexible laminate as described above, it is possible to perform the lamination of multi-layers in one processing step without producing voids and the warp of the resultant laminate. Accordingly, the flexible laminate having such properties inherent in polyimide as the excellent heat resistance, electrical properties, and mechanical strength or the flexible laminate which excels in various properties such as the dimensional stability and resistance to soldering heat in addition to the properties mentioned above may be manufactured with high productivity at a low cost. Further, it is possible to manufacture the flexible double-sided copper-clad laminates and the flexible laminated boards of various multi-layer structures using the thermoplastic polyimide resin film as a bonding sheet for embedding circuits or as an interlayer insulating material in a simple step with high productivity.

In accordance with the preferred embodiments of the present invention, the thermoplastic polyimide resin layer mentioned above has a glass transition temperature (Tg) of 180-280° C. or further a melt viscosity of 5×10¹-1×10⁴ [Pa·S] measured at a shear rate in the range of 50-500 [sec⁻¹] at an extrusion temperature higher than the melting point of the above-mentioned resin by 30° C., preferably is a thermoplastic polyimide resin having a recurring structural unit represented by the general formula (1) to be described hereinafter, preferably a thermoplastic polyimide resin having a recurring structural unit represented by the general formula (5), more preferably a thermoplastic polyimide resin containing the recurring structural units represented by the formulas (6) and (7) to be described hereinafter or a thermoplastic polyimide resin containing the recurring structural units represented by the formulas (6) and (8) to be described hereinafter. Accordingly, by making use of the thermoplasticity of these polyimide resins, they can be easily laminated on a substrate by heating under pressure at a temperature of not less than the glass transition temperature Tg and not more than the melting point thereof, preferably at a temperature in the range of 300-380° C., through the physical change of state from melting to solidification. Particularly, when a mixture of a crystalline thermoplastic polyimide resin with other thermoplastic resin which will assume a melt state at a laminating processing temperature, preferably other thermoplastic resin whose melting point is 280-350° C., is used, it is possible to further increase the bond strength at the time of lamination. More preferably, if a felt-like cushioning material, preferably a felt-like cushioning material of aromatic polyamide or polybenzoxazol, is interposed between a press plate which is arranged in contact with the material to be heated under application of pressure and a pressing platen of a pressing machine at the time of the above-mentioned heating under pressure, it is possible to obtain a thick flexible laminated board which is smooth and uniform even with a large area.

### BRIEF DESCRIPTION OF THE DRAWINGS

Other objects, features, and advantages of the invention will become apparent from the following description taken together with the drawings, in which:

FIG. 1 is a schematic diagram illustrating TMA curves of an unoriented thermoplastic polyimide resin film and a biaxially oriented thermoplastic polyimide resin film;

FIG. 2 is a fragmentary sectional view schematically illustrating an example of the structure of a flexible double-sided copper-clad laminate according to the present invention;

FIG. 3 is a fragmentary sectional view schematically illustrating another example of the structure of the flexible double-sided copper-clad laminate according to the present invention;

FIG. 4 is a fragmentary sectional view schematically illustrating an example of the structure of a multi-layer flexible laminate according to the present invention; and

FIG. 5 is a fragmentary sectional view schematically illustrating another example of the structure of the multi-layer flexible laminate according to the present invention.

### DETAILED DESCRIPTION OF THE PREFERRED EMBODIMENTS

As described above, a flexible laminate and a method for manufacturing the same according to the present invention are based on the so-called laminating method using a thermoplastic polyimide resin film obtained by melt extrusion of a thermoplastic polyimide resin or a biaxially oriented thermoplastic polyimide resin film and bonding it to a metal foil or a conductor circuit layer by heating under pressure.

Heretofore, the formation of a film-like polyimide layer had been performed by imidizing a polyamic acid which is a precursor of a thermoplastic polyimide after applied onto a copper foil or a polyimide resin film, as mentioned above. Therefore, the resultant layer contained a monomer residue and a residual solvent, which caused the deterioration of electrical properties. Further, the gas had caused at the time of bonding by heating under pressure owing to impurities, and thus voids had easily produced between layers. Moreover, another problem was complicated processing steps of applying and heating for lamination. However, by the development of a thermoplastic polyimide resin film which can be melted and molded as described hereinafter, the manufacture of the flexible laminates of various structures can be performed by the laminating method as in the present invention.

The following points may be cited as the characteristic features of the manufacture of the flexible laminate by such a laminating method.

(1) The thermoplastic polyimide to be used can be melted and molded like the common plastic materials, and a polyimide resin film may be formed by a T-die extrusion method which excels in mass productivity.

(2) Since the imidization reaction has already been completed at the stage of manufacturing resin pellets, there is no need to carry out the imidization reaction at the time of forming a film. Accordingly, it is possible to use a high-purity thermoplastic polyimide resin film containing no impurity such as a monomer residue and a residual solvent.

(3) The lamination is not performed by the aid of the imidization reaction of a polyamic acid or the resin curing reaction, but by making use of the thermoplasticity of the polyimide resin through the physical change of state from melting to solidification caused by a hot pressing.

(4) The hot pressing of the thermoplastic polyimide resin film is carried out not in the state melted thoroughly, but under the temperature conditions of not less than Tg and not more than the melting point.

(5) By using a heat-resistant felt-like cushioning material and interposing it between a press plate which is arranged in contact with the material to be heated under application of pressure and a pressing platen of a pressing machine at the time of the hot pressing, it is possible to obtain a thick flexible laminated board which is smooth and uniform even with a large area.

(6) The board having a circuit formed thereon can be further subjected to lamination.

The following points may be cited as the advantages of the method of the present invention for manufacturing the flexible laminate by the laminating method over the conventional processes.

(1) There is obtained a circuit board having such characteristics inherent in polyimide as excellent heat resistance, electrical properties, and mechanical strength, without using an adhesive agent which is inferior in heat resistance. Accordingly, it is possible to manufacture a board wholly made of polyimide.

(2) Since the thermoplastic polyimide resin film has high purity, it excels in resistance to migration.

(3) By the lamination of the thermoplastic polyimide resin film on a metal foil or a conductor layer, the circuit board having high bond strength is obtained.

(4) Although the lamination resorting to the imidization reaction will pose such problems as the occurrence of voids due to the generation of gas and the warp of the resultant laminate, the lamination making use of the thermoplasticity of the thermoplastic polyimide resin film will not pose these problems.

(5) Since the lamination is performed only by heating under pressure the thermoplastic polyimide resin film formed in advance, the processing step is simple. Further, by piling up a plurality of layers, the multi-layer lamination can be performed in one step.

In a preferred embodiment of the present invention, a biaxially oriented thermoplastic polyimide resin film is bonded to a metal foil or a conductor circuit layer by heating them under pressure.

Since a thermoplastic polyimide resin is thermoplastic and thus has a thermal expansion coefficient larger than that of the conventional thermosetting polyimide resin (the thermal expansion coefficient of the thermoplastic polyimide resin is 40×10⁻⁶-60×10⁻⁶/K), when it is laminated on a metal foil having a small thermal expansion coefficient (the thermal expansion coefficient is about 20×10⁻⁶/K), the warp will easily occur due to the dimensional change caused during the cooling to room temperature. Accordingly, the lamination of a thermoplastic polyimide resin film on a metal foil or the like will pose such a problem that the lamination conditions for manufacturing a flexible laminate excelling in dimensional stability or the like can be controlled only with difficulty.

As described above, in the technical field of a flexible laminate the level of demand for high-density mounting has became higher. In order to manufacture a wiring board of high accuracy, the material which excels in such mechanical properties as dimensional stability, the thermal expansion coefficient, and the modulus in tension is required. Further, when a thermoplastic film is used for a flexible wiring board, the film becomes soft generally at a temperature exceeding the glass transition temperature Tg thereof at the time of solder reflow for mounting parts thereon, for example, and thus deformation such as warp or twist of the flexible circuit board itself will occur. This will pose a serious problem. Also in the case of the thermoplastic polyimide resin film, since its glass transition temperature Tg is equal to or lower than the processing temperature of lead free solder, further improvement in the resistance to soldering heat is required.

The present inventors, after pursuing a diligent study on the phenomena mentioned above, have been found that it is possible to lower the thermal expansion coefficient of a crystalline thermoplastic polyimide resin film to about 20 ppm/K or approximate values equivalent to that of a copper foil or a thermosetting polyimide resin film by biaxially stretching the crystalline thermoplastic polyimide resin film, and further that it is possible to heighten the glass transition temperature Tg thereof by biaxially stretching the film so that it holds rigidity even at a temperature of 300° C. or more.

That is, by biaxially stretching a thermoplastic polyimide resin film, the isotropic molecular orientation of the thermoplastic polyimide resin occurs in the planar direction of the film, and the thermal expansion coefficient thereof decreases. Furthermore, by adjusting the orientation temperature and the stretching speed, it is possible to adjust the thermal expansion coefficient thereof so that it is decreased to a level equivalent to that of a copper foil or a thermosetting polyimide resin film.

Further, by setting the molecular orientation by heating while restricting shrinkage after biaxial orientation (heat setting), thermal adhesion may be attained while maintaining the decreased thermal expansion coefficient at a temperature range of not less than the glass transition temperature Tg and not more than the melting point thereof, without returning to the original thermal expansion coefficient even at a temperature range exceeding the glass transition temperature Tg of the unoriented thermoplastic polyimide resin used. Moreover, the residual stress of the film produced at the time of extrusion is also removed, and the resultant film excels in the dimensional stability so that it does not produce change in size even when heated to the temperature allowing adhesion and cooled. Accordingly, it is possible to manufacture a laminate which excels in dimensional accuracy and dimensional stability and will not produce warp or the like at the time of the lamination onto a metal foil or a conductor circuit.

Furthermore, by biaxially stretching a thermoplastic polyimide resin film, it is possible to make its glass transition temperature high. For example, when the thermoplastic polyimide resin film having the glass transition temperature Tg of 258° C. is biaxially stretched, the glass transition temperature increases to 305° C. It is possible to increase the glass transition temperature of a thermoplastic polyimide resin film by 10-80° C. by the biaxial orientation, and the resultant film holds rigidity even at a temperature of 300° C. or more. Consequently, the softening of the film will not occur also at a temperature exceeding the glass transition temperature Tg of the unoriented film, and the film exhibits improved resistance to soldering heat at the time of solder reflow when used as a printed circuit board.

It is possible to measure the glass transition temperature through the analysis by a TMA test which measures the thermal expansion coefficient, which will be described below with reference to an appended drawing.

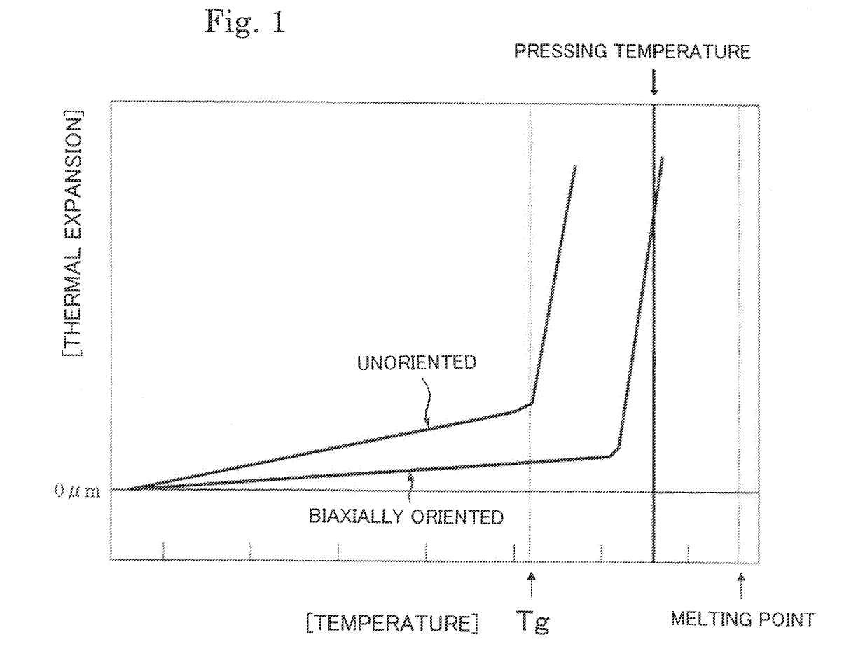

FIG. 1 is a schematic diagram illustrating TMA curves of an unoriented thermoplastic polyimide resin film and an oriented thermoplastic polyimide resin film. As being clear from FIG. 1, the glass transition temperature Tg increases by biaxially stretching a thermoplastic polyimide resin film. Incidentally, the glass transition temperature Tg is indicated by the intersection of the tangent of the line segment of which the thermal expansion coefficient is rising gently and the tangent of the line segment of which the thermal expansion coefficient is rising rapidly.

Next, the biaxial orientation of a thermoplastic polyimide resin film will be described.

The orientation step may be carried out by either simultaneous biaxial orientation or successive biaxial orientation. The orientation temperature is desired to be in the range of 250-275° C. If the orientation temperature is unduly low, the stress required for stretching is high, and thus the orientation will become impossible or will cause breakage of the film during the orientation step or uneven orientation of the film. Conversely, if the orientation temperature is unduly high, the molecular orientation will be small and the effect of decreasing the thermal expansion coefficient by the orientation will not be appeared.

The draw ratio is desired to be in the range of 2.5 to 5 times. If the draw ratio is unduly low, the molecular orientation will be insufficient and the thermal expansion coefficient will not decrease, or rumple will occur in the film during the heat setting. Conversely, if the draw ratio is unduly high, such problems as the breakage of the film will occur at the time of orientation.

The orientation speed is desired to be in the range of 100-1000%/min. If the orientation speed is low, the molecular orientation will be small and the thermal expansion coefficient will not decrease. Incidentally, the upper limit of the orientation speed is restricted by the capacity of the orientation equipment.

Next, the conditions for heat setting may be arbitrarily set within the ranges that the heating temperature falls in the range of 280-380° C., preferably 290-330° C., the restricted shrinkage falls in the range of 2 to 20%, preferably 4-10%, and the period of time falls in the range of 1-5000 minutes. If the heat setting temperature is unduly low, a large dimensional change will generate when the orientated film is re-heated. Conversely, if the heat setting temperature is higher than the melting point, the molecular orientation caused by the stretching will disappear.

As the biaxial orientation method, any well-known method such as a stretching method using two or more rolls, a stretching method using a tenter, a stretching method by rolling using rolls, and a tubular stretching method may be used. Although the stretching method using a tenter which has been industrially often used includes the successive orientation which performs the separate steps of stretching in the longitudinal direction and stretching in the transverse direction respectively in two stages and the simultaneous orientation which performs the stretching in the longitudinal direction and the stretching in the transverse direction simultaneously, the biaxial orientation may be performed by any method.

In the case of the successive biaxial orientation, first a thermoplastic polyimide resin film to be stretched is preliminarily heated to 250-300° C. and then stretched in one direction by 2 to 5 times the original size in the state uniformly heated to a predetermined temperature. Subsequently, it is stretched at a temperature in the range of 250-300° C. in one direction orthogonal to the above mentioned stretching direction by 2 to 5 times the original size. Then, the film is heat-set under stretching at a temperature in the range of 280-380° C. In the heat setting, although the shrinkage of the film will occur after orientation, the film is gradually cooled while restricting shrinkage to 2-20% by maintaining the stretched state which restrains shrinkage.

In the case of the simultaneous biaxial orientation, a thermoplastic polyimide resin film to be stretched is preliminarily heated to 250-300° C. and then simultaneously stretched in two directions perpendicularly intersecting each other by 2 to 5 times the original size in the state uniformly heated to a predetermined temperature. Then, the film is heat-set under stretching at a temperature in the range of 280-380° C. In the heat setting, although the shrinkage of the film will occur after orientation, the film is gradually cooled while restricting shrinkage to 2-20% by maintaining the stretched state which restrains shrinkage.

By biaxially stretching a thermoplastic polyimide resin film as mentioned above, it is possible to produce the biaxially oriented thermoplastic polyimide resin film which exhibits the thermal expansion coefficient falling in the range of 5-30 ppm/K, preferably 10-25 ppm/K, in any direction of the MD direction and the TD direction and the difference in the thermal expansion coefficient between the MD direction and the TD direction of less than 20 ppm/K, so that the warp which will occur at the time of lamination on a metal foil can be prevented effectively. Further, by biaxially stretching a thermoplastic polyimide resin film, it is possible to heighten its glass transition temperature Tg by 10-80° C. higher than the glass transition temperature Tg of an unoriented thermoplastic polyimide resin film, thereby improving the resistance to soldering heat. Moreover, even when the film is exposed to the heat history below the melting point, the film is capable of maintaining the low thermal expansion coefficient and holding good dimensional stability and required bond strength, and will not cause flow out of resin at the time of the lamination on a copper foil etc. by properly selecting the laminating conditions.

The biaxially oriented thermoplastic polyimide resin film obtained as described above can be easily laminated on a member to be heated under pressure, such as a copper foil, a conductor circuit layer, and a polyimide film, by heating under pressure at a temperature not less than the glass transition temperature Tg of the unoriented thermoplastic polyimide resin, preferably not less than the glass transition temperature Tg of the biaxially oriented thermoplastic polyimide resin film, and not more than the melting point, preferably in the range of 300-380° C., but not in the completely melt state. There is an advantage that the lamination temperature can be made low in proportion as the lamination pressure is high. However, generally the resultant laminate tends to suffer dimensional change if the lamination pressure is unduly high. Accordingly, the proper lamination pressure is in the range of 5-50 kgf/cm².

As the above-mentioned thermoplastic polyimide resin film which has not been subjected to the biaxial orientation, both of the thermoplastic polyimide resin film obtained by melt extrusion of a thermoplastic polyimide resin and the conventional thermoplastic polyimide resin film obtained by the casting method may be used. Particularly, when the thermoplastic polyimide resin film obtained by melt extrusion of a thermoplastic polyimide resin is used, the following advantages are obtained.

(1) The polyimide resin film can be formed by a T-die extrusion method which excels in mass-productivity.

(2) Since the imidization reaction has been already completed in the production stage of resin pellets and there is no need to effect the imidization reaction at the time of film formation, it is possible to use the high-purity thermoplastic polyimide resin film containing no impurity, such as a monomer residue and a residual solvent.

(3) Since the purity of the thermoplastic polyimide resin film is high, it excels in resistance to migration.

As the materials of the thermoplastic polyimide film to be used in the present invention, any thermoplastic polyimide resin and the so-called polyetherimide resin as described hereinafter may be used, and these materials can be used either singly or in the form of a mixture of two or more members. In the present specification, the term “thermoplastic polyimide resin” should be understood to be including the thermoplastic polyimide resins and the polyetherimide resins, and the term “thermoplastic polyimide resin film” means the polyimide resin film possessed of the thermoplasticity (thermal reversibility of hardening and softening). Although the inherent viscosity or logarithmic viscosity of the thermoplastic polyimide resin to be used in the present invention is not limited a particular value, it is generally preferred to be in the range of about 0.35-1.30 dl/g, preferably about 0.40-1.00 dl/g. If the inherent viscosity is lower than the above-mentioned range, the resin has a small molecular weight and is inferior in characteristics. Conversely, if it is unduly higher than the above-mentioned range, the molecular weight of the resin is too large, which undesirably results in insufficient flowability during extrusion molding. The inherent viscosity of the thermoplastic polyimide resin is obtained by measuring the viscosity of a mixed solvent of 9 parts by volume of phenol and 1 part by volume of p-chlorophenol and the viscosity of a solution obtained by dissolving a sample in this mixed solvent (concentration: 0.5 g/dl) respectively at 30° C. with the Ubbellohde viscometer and calculating the following equation (I):

$$Inherent Viscosity = \frac{ln ( t / {t}_{0} )}{C} \qquad ( I )$$

wherein “t” represents the falling time (sec.) of the solution, “t₀” represents the falling time (sec.) of the mixed solvent, and “C” represents the concentration of the solution (g/dl).

As the above-mentioned thermoplastic polyimide resin, those having a recurring structural unit represented by the following general formula (1) may be cited.

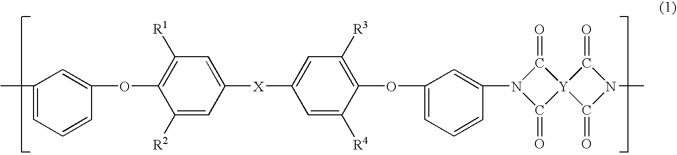

In the above-mentioned general formula (1), X represents a direct bond, —SO₂—, —CO—, —C(CH₃)₂—, —C(CF₃)₂—, or —S—, R¹, R², R³, and R⁴ independently represent a hydrogen atom, an alkyl group of 1-6 carbon atoms, an alkoxy group, a halogenated alkyl group, a halogenated alkoxy group, or a halogen atom, and Y represents a group selected from the group consisting of the groups represented by the following formulas (2).

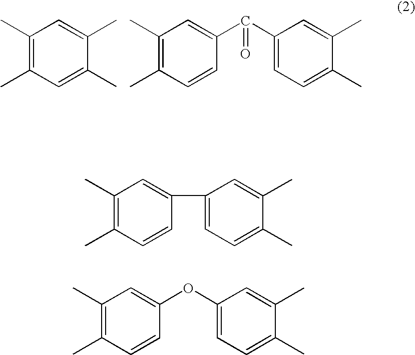

The thermoplastic polyimide resin having the recurring structural unit represented by the above-mentioned general formula (1) can be produced by reacting an etherdiamine represented by the following general formula (3) and a tetracarboxylic dianhydride represented by the following general formula (4) in the presence or absence of an organic solvent and chemically or thermally imidizing the obtained polyamic acid. The concrete method for production thereof can make use of the conditions for the known method of producing polyimide.

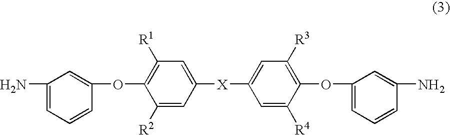

In the above-mentioned general formula (3), R¹, R², R³, and R⁴ represent the same meanings as those described in relation to the above-mentioned formula (1).

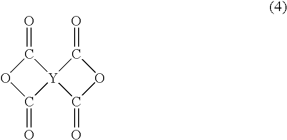

In the above-mentioned general formula (4), Y represents the same meaning as that described in relation to the above-mentioned general formula (1).

As concrete examples of R¹, R², R³, and R⁴ in the general formulas (1) and (3) mentioned above, a hydrogen atom, an alkyl group such as methyl group and ethyl group, an alkoxy group such as methoxy group and ethoxy group, a halogenated alkyl group such as fluoromethyl group and trifluoromethyl group, a halogenated alkoxy group such as fluoromethoxy group, a halogen atom such as a chlorine atom and a fluorine atom may be cited. Preferably, it is a hydrogen atom. X in the formula is a direct bond, —SO₂—, —CO—, —C(CH₃)₂—, —C(CF₃)₂—, or —S—, preferably a direct bond, —SO₂—, —CO—, or —C(CH₃)₂—.

In the general formulas (1) and (4) mentioned above, Y is represented by the formula (2) mentioned above, preferably that obtained by using pyromellitic dianhydride as an acid dianhydride.

A more preferred thermoplastic polyimide resin is a thermoplastic polyimide resin having a recurring structural unit represented by the following formula (5).

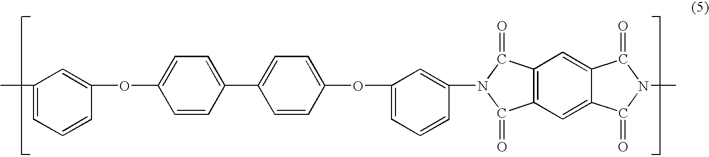

Incidentally, the thermoplastic polyimide resin having the recurring structural unit represented by the above-mentioned formula (5) is commercially available under the registered trademark “AURUM” from Mitsui Chemicals, Inc.

The thermoplastic polyimide resin having the recurring structural units represented by the following formulas (6) and (7) may also be cited as a preferred example.

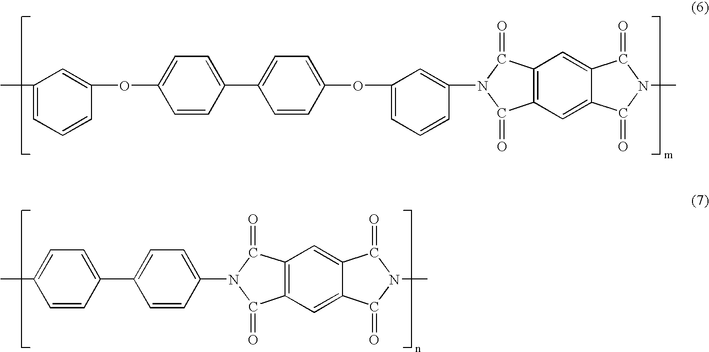

In the formulas (6) and (7) mentioned above, “m” and “n” represent a molar ratio of each structural unit (a block polymer is not necessarily meant), and m/n is preferred to be in the range of 4-9, preferably 5-9, more preferably 6-9.

The thermoplastic polyimide resin having the recurring structural units represented by the formulas (6) and (7) mentioned above can be produced by reacting a corresponding etherdiamine and a corresponding tetracarboxylic dianhydride in the presence or absence of an organic solvent and chemically or thermally imidizing the obtained polyamic acid. The concrete method for production thereof can make use of the conditions for the known method of producing polyimide.

In the present invention, it is also preferred to use a thermoplastic polyimide resin having a recurring structural unit represented by the following formula (8) in place of or in combination with the thermoplastic polyimide resin having the recurring structural unit represented by the above-mentioned general formula (1). The use of a copolymer of a monomer having the structural unit represented by the above-mentioned formula (6) with a monomer having the structural unit represented by the following formula (8) is also preferred. In this case, the proper molar rate of the recurring structural unit represented by the above-mentioned formula (6) to the recurring structural unit represented by the following formula (8) is 1:0 to 0.75:0.25.

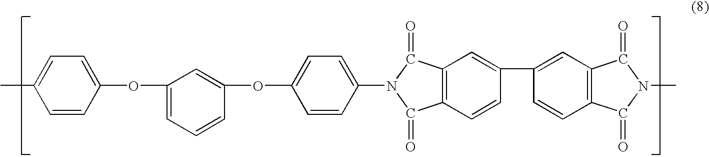

The thermoplastic polyimide resin having the recurring structural unit represented by the above-mentioned formula (8) can be produced by reacting a corresponding etherdiamine and a corresponding tetracarboxylic dianhydride in the presence or absence of an organic solvent and chemically or thermally imidizing the obtained polyamic acid. The concrete method for production thereof can make use of the conditions for the known method of producing polyimide.

As a polyetherimide resin, those having a recurring structural unit represented by the following general formula (9) may be cited.

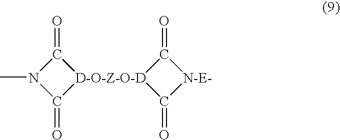

In the above-mentioned general formula (9), D represents a trivalent aromatic group, and both E and Z represent a divalent residue.

The polyetherimide resin having the recurring structural unit represented by the above-mentioned general formula (9) can be produced by reacting a corresponding etherdiamine and a corresponding tetracarboxylic dianhydride in the presence or absence of an organic solvent and chemically or thermally imidizing the obtained polyamic acid. The concrete method for production thereof can make use of the conditions for the known method of producing polyimide.

As concrete examples of the polyetherimide resin, for example, polyetherimide resins having at least one recurring structural unit selected from the recurring structural units represented by the following general formulas (10)-(12) may be cited.

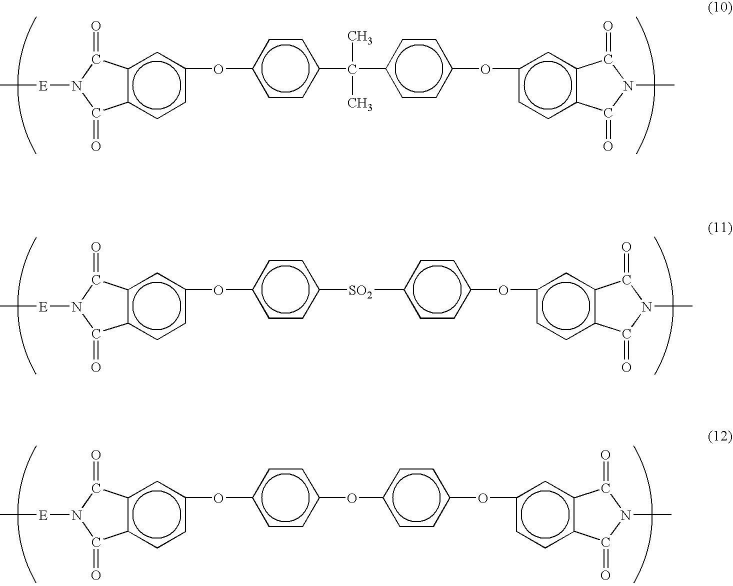

In the above-mentioned general formulas (10)-(12), the symbol E represents a divalent aromatic residue, such as the groups represented by the following formulas.

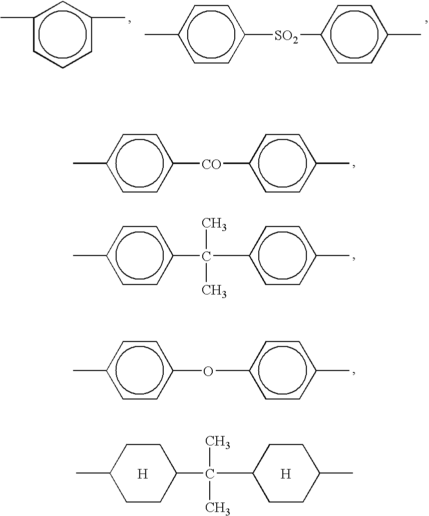

Particularly, preferably used polyetherimide resin is a polyetherimide resin having a recurring structural unit represented by the following formula (13).

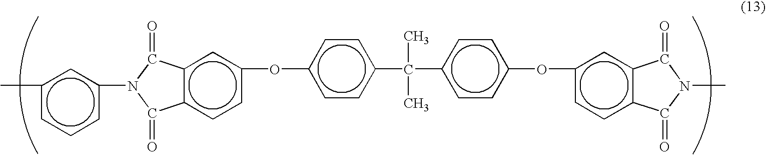

The polyetherimide resin having the recurring structural unit represented by the above-mentioned formula (13) is commercially available under the registered trademark “ULTEM” from General Electric Company.

A diamine and a tetracarboxylic dianhydride used as raw materials of the above thermoplastic polyimide resins may be used singly or in combination of a plurality members and may contain other copolymerizable ingredients insofar as the object of the present invention will not be impaired. Further, a plurality of polyimide resins obtained from different monomers may be used arbitrarily as a polymer blend insofar as the object of the present invention will not be impaired.

Other resin may be added to the thermoplastic polyimide resin to be used in the present invention. For example, a polyamide resin, preferably a wholly aromatic polyamide resin, a polyamide-imide resin, a polyarylate resin, a polyether-nitrile resin, a polyphenylene sulfide resin, a polyethersulfone resin, a polyether-ether-ketone resin, a liquid crystal polymer, etc. may be included in the resin within the range which will not impair the object of the present invention. Particularly, in the case of a mixture of a crystalline thermoplastic polyimide resin with other thermoplastic resin which will assume a molten state at a temperature of the lamination step, preferably other thermoplastic resin having a melting point of 280-350° C., the bond strength at the time of lamination may be further increased.

The thermoplastic polyimide resin film of the present invention may further contain any additive, such as colorants, release agents, various stabilizers, plasticizers, lubricants, various inorganic fillers, and oil, insofar as the object of the present invention may be accomplished.

The melt viscosity which allows the film formation by extrusion molding is in the range of 5×10¹-1×10⁴ [Pa·S], preferably 4×10²-3×10³ [Pa·S]. If the melt viscosity is less than 5×10¹ [Pa·S], the drawdown after discharge from a die is so remarkable that the production of the film will be impossible. Conversely, if the melt viscosity exceeds 1×10⁴ [Pa·S], the load applied to an extrusion screw at the time of melting will become large or the discharge from a die will become difficult, and thus the manufacture of the film will be impossible.

Next, the manufacturing steps of a thermoplastic polyimide resin film will be described.

The polyimide resin film of the present invention can be manufactured by a melt extrusion method. For example, pellets or powder of a polyimide resin, and other resin and an additive, as desired, are dry-mixed with a Henschel mixer, a ribbon blender, etc. and then melted, kneaded, and extruded with a twin-screw kneading extruder. An extruded strand is cooled in water and cut to obtain pellets of a mixture. Subsequently, the obtained pellets are dried by heating to remove absorbed water and then melted by heating with a single- or twin-screw extruder. The molten resin discharged in the shape of a flat film from a T-die provided at a leading end of the extruder is cooled and solidified by being brought into contact with or pressed onto a cooling roll to obtain a polyimide resin film. Alternatively, a method of carrying out direct extrusion of pellets or powder without kneading may also be adopted.

The thickness of a thermoplastic polyimide resin film is not restricted to a particular one and is usually in the range of 10 μm-1 mm, preferably 20 μm -400 μm.

A polyimide resin film generally used is obtained by casting a solution containing a polyamic acid on a roll or a base film and then carrying out a dehydrating condensation reaction. Therefore, a monomer and a solvent used at the time of the polymerization reaction still remains in the film, which results in the deterioration of its electrical properties or transparency.

On the other hand, in the case of a thermoplastic polyimide resin film, a preliminary process for producing pellets by kneading extrusion is required before performing the T-die extrusion molding. Since a monomer residue and a solvent which will remain in the polyimide resin after the process of the polymerization reaction and the dehydrating condensation reaction are removed during the melt kneading in the pellet production step, there is obtained a thermoplastic polyimide resin film which can fully exhibit the electrical properties and mechanical strength inherent in the material itself and has a highly transparency.

By further biaxially stretching the thermoplastic polyimide resin film produced as described above in the manner mentioned above, the biaxially oriented thermoplastic polyimide resin film of the present invention is obtained.

When the thermoplastic polyimide resin film produced by the T-die extrusion method as described above or the biaxially oriented thermoplastic polyimide resin film is bonded to a copper foil, a conductor layer, or a usual polyimide resin film by heating under pressure, it is possible to further increase the bond strength by performing a modification treatment to a film surface. As a method of surface modification treatment, a usual surface treatment such as a corona discharge treatment, a plasma treatment, an ozone treatment, an excimer laser treatment, or an alkali treatment may be adopted. Among other treatments, a corona discharge treatment and a plasma treatment are preferred from the viewpoint of cost or a treating effect.

Next, some embodiments of a flexible laminated board obtained by the method of the present invention will be described with reference to the drawings. However, the present invention is not limited to the following embodiments and may be carried out in various embodiments.

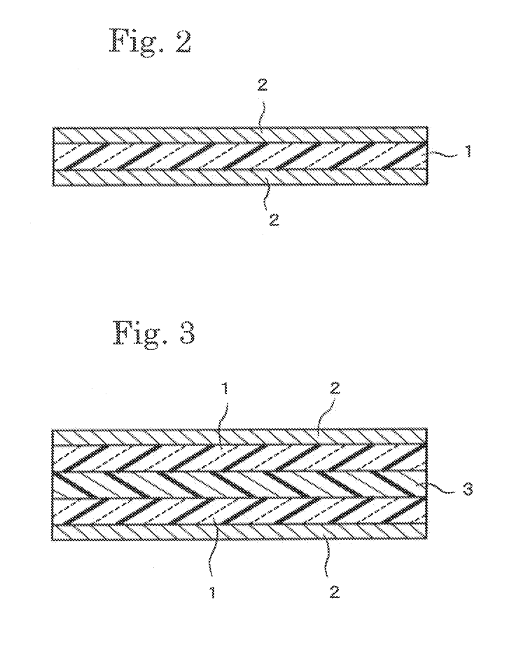

First, FIG. 2 and FIG. 3 illustrate two structures of flexible double-sided copper-clad laminate.

The flexible double-sided copper-clad laminate shown in FIG. 2 is obtained by preparing copper foils of which at least one side has been subjected to a surface roughening treatment or an adhesion modification treatment, superposing the above-mentioned thermoplastic polyimide resin film (or the biaxially oriented thermoplastic polyimide resin film) 1 on the treated side of the copper foil 2, superposing the copper foil 2 on the opposite side of the thermoplastic polyimide film (or the biaxially oriented thermoplastic polyimide resin film) 1 mentioned above so that the treated side of the copper foil 2 is brought into contact with the film 1, and heating them under pressure. Alternatively adoptable construction is a two-layer construction which is obtained by superposing the above-mentioned thermoplastic polyimide resin film (or the biaxially oriented thermoplastic polyimide resin film) on the treated side of a copper foil of which at least one side has been subjected to a surface roughening treatment or an adhesion modification treatment, and heating them under pressure.

On the other hand, the flexible double-sided copper-clad laminate shown in FIG. 3 is obtained by superposing the above-mentioned thermoplastic polyimide resin films (or the biaxially oriented thermoplastic polyimide resin films) 1 on both sides of a polyimide resin film 3 of which both sides have not been subjected to any surface treatment or have been subjected to an adhesion modification treatment, further superposing copper foils 2 of which at least one side has been subjected to a surface roughening treatment or an adhesion modification treatment on the outer opposite sides of the films 1 in such a manner that the treated surface of each copper foil 2 faces inward, and heating them under pressure.

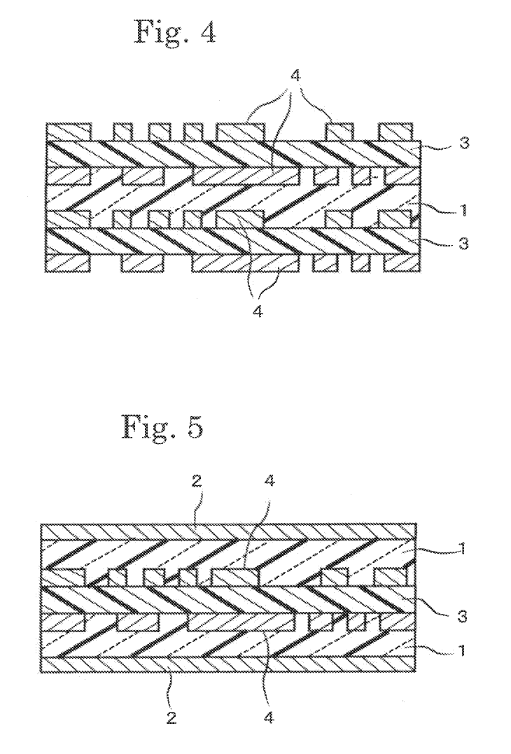

Next, FIG. 4 illustrates an embodiment using the thermoplastic polyimide resin film (or the biaxially oriented thermoplastic polyimide resin films) as a bonding sheet for embedding circuits. This multi-layer flexible laminate is obtained by sandwiching the above-mentioned thermoplastic polyimide resin film (or the biaxially oriented thermoplastic polyimide resin film) 1 between double-sided flexible boards which comprises a polyimide resin film 3 and conductor circuit layers 4 formed on both sides of the film 3 and of which both sides have not been subjected to any surface treatment or have been subjected to an adhesion modification treatment, and heating them under pressure.

Finally, FIG. 5 illustrates an embodiment using the thermoplastic polyimide resin films (or the biaxially oriented thermoplastic polyimide resin films) as an interlayer insulating material for embedding circuits. This multi-layer flexible laminate is obtained by superposing the above-mentioned thermoplastic polyimide resin films (or the biaxially oriented thermoplastic polyimide resin films) 1 on the outer opposite sides of a double-sided flexible board, respectively, which board comprises a polyimide resin film 3 and conductor circuit layers 4 formed on both sides of the film 3 and of which both sides have not been subjected to any surface treatment or have been subjected to an adhesion modification treatment, further superposing copper foils 2 of which at least one side has been subjected to a surface roughening treatment or an adhesion modification treatment on the outer opposite sides of the films in such a manner that the treated surface of each foil faces inward, and heating them under pressure.

The thermoplastic polyimide resin film or the biaxially oriented thermoplastic polyimide resin film of the present invention allows the following applications.

(1) They can be used as coverlay films of various flexible substrates or planar heating elements.

(2) They can be laminated on a metal foil of copper, stainless steel, aluminum, nickel, or the like. Preferably, they can be used as a laminating material for a copper foil. It is also possible to perform the simultaneous interlaminar connection by using metal paste or a metal bump and making a part penetrating an insulating layer (the thermoplastic polyimide resin film or the biaxially oriented thermoplastic polyimide resin film) formed on the surface of a metal foil.

(3) It is possible to perform whole multi-layer lamination with one laminating step.

(4) It is possible to perform successive lamination, for example, by using thermoplastic polyimide resin films having different Tg or biaxially oriented thermoplastic polyimide resin films one by one. Further, it is possible to perform successive lamination by first laminating with a thermoplastic polyimide resin film having high Tg or a biaxially oriented thermoplastic polyimide resin film, and then repeating lamination with a thermoplastic polyimide resin film having lower Tg or a biaxially oriented thermoplastic polyimide resin film, though the number of times of lamination will be restricted.

Now, the present invention will be more specifically described below with reference to working examples. However, the present invention is not limited to the following examples. The present invention may be embodied in other specific forms including various modifications, changes, and corrections added based on the knowledge of a person skilled in the art within the range not departing from the spirit or essential characteristics thereof.

### Production Example 1 of Thermoplastic Polyimide Resin Film:

A used resin pellet contained a thermoplastic polyimide having the chemical constitutional formulas represented by the aforementioned formulas (6) and (7) (AURUM (registered trademark) PD500A manufactured by Mitsui Chemicals, Inc.; Tg: 258 [° C.], melting point: 380 [° C.], melt viscosity measured at the shear rate of 500 sec⁻¹:700 [Pa·S]) and a thermoplastic polyimide having the chemical constitutional formula represented by the aforementioned formula (6) (AURUM (registered trademark) PD450C manufactured by Mitsui Chemicals, Inc.; Tg: 250 [° C.], melting point: 388 [° C.], melt viscosity measured at the shear rate of 500 sec⁻¹:500 [Pa·S]) in the ratio of 90:10. The melt viscosity [Pa·S] of the thermoplastic polyimide resin used for extrusion molding was measured using a flow tester CFT-500 manufactured by Shimadzu Corporation according to JIS K-7199.

The above-mentioned resin pellets were dried at 180° C. for 10 hours in a hot-air type high temperature chamber and then subjected to film extrusion which was performed using a single screw extruder with a screw diameter of 50 mm and a T-die provided at its leading end. The film extrusion temperature was 420° C. A thermoplastic polyimide resin film (hereinafter referred to as “thermoplastic PI film a”) of 50 μm thickness was obtained by cooling and solidifying the molten resin material discharged from the T-die with a cooling roll of a temperature controlled to 220° C. and then subjecting both sides of the resultant film to a corona discharge treatment. The corona discharge treatment of the film surface was performed under the conditions of watt density 120 W/m²/min using a corona treatment device manufactured by Tomoe Engineering Co., Ltd.

### Production Example 2 of Thermoplastic Polyimide Resin Film:

A thermoplastic polyimide resin film (hereinafter referred to as “thermoplastic PI film b”) of 50 μm thickness was obtained by following the same procedure and the corona discharge treatment as in Production Example 1 of Thermoplastic Polyimide Resin Film mentioned above, except that the resin pellet containing a thermoplastic polyimide having the chemical constitutional formulas represented by the aforementioned formulas (6) and (7) (AURUM (registered trademark) PD500A manufactured by Mitsui Chemicals, Inc.; Tg: 258 [° C.], melting point: 380 [° C.], melt viscosity measured at the shear rate of 500 sec⁻¹:700 [Pa·S]) and a polyetherimide resin having the chemical constitutional formula represented by the aforementioned formula (13) (ULTEM (registered trademark) 1000P manufactured by General Electric Company) in the ratio of 90:10 was used.

### Polyimide Resin Film:

Since the polyimide having the chemical constitutional formula represented by the aforementioned formula (7) is generally available as a film of polyimide resin (Kapton (registered trademark) 200H manufactured by Du Pont-Toray Co., Ltd.), this commercially available polyimide resin film was used. This polyimide resin is a straight-chain polymer which does not exhibit thermoplasticity (thermal reversibility between hardening and softening) and cannot be extrusion-molded if it is used independently. Therefore, this commercially available polyimide resin film (hereinafter referred to as “PI film”) is that obtained by casting a solution containing a polyamic acid of a precursor on a roll or a flat surface and then carrying out a dehydrating condensation reaction.

### Example 1

Copper foils of 18 μm thickness were respectively superposed on both sides of the thermoplastic PI film “a” of 50 μm thickness. They were sandwiched between stainless steel plates (hereinafter referred to as “SUS plate”) from both sides. Further, two sheets of Fujilon STM manufactured by FUJICO Co., Ltd. as a felt-like cushioning material made of polybenzoxazol were respectively superposed on outer opposite sides of the SUS plates, and they were set in a vacuum hot pressing machine manufactured by KITAGAWA SEIKI Co., Ltd. Thereafter, the inside pressure of the pressing machine was reduced to 1.0 kPa, the temperature was increased to 300° C. at the rate of temperature increase of 5° C./min. under pressure of the initial pressure of 10 kgf/cm², then the pressure was raised to the secondary-forming pressure of 25 kgf/cm², and this state was held for 10 minutes. Thereafter, the pressing machine was cooled slowly to room temperature to obtain a flexible double-sided copper-clad laminate as shown in FIG. 2. The obtained copper-clad laminate was used to evaluate various characteristics as shown in Table 1. The results are shown in Table 1 collectively.

### Example 2

A flexible double-sided copper-clad laminate aimed at was obtained by faithfully following the procedure of Example 1 except that the pressing temperature was changed to 330° C. The obtained copper-clad laminate was used to evaluate various characteristics. The results are shown in Table 1.

### Example 3

A flexible double-sided copper-clad laminate aimed at was obtained by faithfully following the procedure of Example 1 except that the pressing temperature was changed to 360° C. The obtained copper-clad laminate was used to evaluate various characteristics. The results are shown in Table 1.

### Example 4

A flexible double-sided copper-clad laminate aimed at was obtained by faithfully following the procedure of Example 1 except that the pressing temperature was changed to 380° C. The obtained copper-clad laminate was used to evaluate various characteristics. The results are shown in Table 1.

### Example 5

A flexible double-sided copper-clad laminate aimed at was obtained by faithfully following the procedure of Example 1 except that the pressing temperature was changed to 330° C. or 380° C. and the cushioning material was changed to P-aramid (aromatic polyamide available under the trade name of “Fujilon 9000” from FUJICO Co., Ltd.). The obtained copper-clad laminate was used to evaluate various characteristics. The results are shown in Table 1.

TABLE 1

| Pressing conditions and | | Examples | | | | | |
|---|---|---|---|---|---|---|---|
| Characteristics | | 1 | 2 | 3 | 4 | 5 | |
| Pressing Temperature | | 300 | 330 | 360 | 380 | 330 | 380 |
| (° C.) | | | | | | | |
| Cushioning Material | | PBO | PBO | PBO | PBO | P-aramid | |
| Sticking of Cushioning | | ◯ | ◯ | ◯ | ◯ | ◯ | Δ |
| Material | | | | | | | |
| Peel | Thermoplastic | 14 | 13 | 14 | 14 | 13 | 14 |
| Strength | PI Film “a” - | | | | | | |
| (N/cm) | Copper Foil | | | | | | |

| | | | | | | |
|---|---|---|---|---|---|---|
| Resistance to Soldering | Good | Good | Good | Good | Good | Good |
| Heat | | | | | | |
| Exudation of Resin | ⊚ | ◯ | ◯ | ◯ | ◯ | ◯ |

Remarks
PBO: polybenzoxazol (trade name “Fujilon STM” manufactured by FUJICO Co., Ltd.)
P-aramid: aromatic polyamide (trade name “Fujilon 9000” manufactured by FUJICO Co., Ltd.

As being clear from the results shown in Table 1, when the thermoplastic PI film of the present invention was used, the sticking of the cushioning material and the exudation of resin were not generated, the adhesiveness of the film to the copper foil was excellent so as to exhibit high peel strength, and the resistance to soldering heat was also good, in any cases of the pressing temperatures of 330° C.-380° C. Incidentally, when the cushioning material made of an aromatic polyamide was used, slight sticking of the cushioning material was observed. Accordingly, it is preferred to use the felt-like cushioning material made of polybenzoxazol as a cushioning material.

Further, when the evaluation was carried out by faithfully following the procedure of Example 1 except that the pressing temperature was changed to 250° C., the peel strength was considerably low and the resistance to soldering heat was also not good, though there was no problem about the sticking of the cushioning material and the exudation of resin. Accordingly, the pressing temperature is desired to be not less than 300° C. On the other hand, when the pressing temperature was changed to 400° C., the exudation of resin was observed, though there was no problem about other various characteristics like Example 1. Accordingly, in the case of the used thermoplastic PI film, it is desirable that the pressing temperature should be less than 400° C. Furthermore, when the evaluation was carried out by faithfully following the procedure of Example 3 except that Fujilon STM arranged as a cushioning material on opposite sides of the SUS plates was changed to Fujilon 6000 cushioning material made of m-aramid, the sticking of the cushioning material was observed, though there was no problem about other various characteristics like Example 3.

Various characteristics shown in Table 1 mentioned above were evaluated as follows (this holds good for Tables 2-5 to be described hereinafter).

### (1) Sticking of Cushioning Material:

Whether the cushioning material used at the time of hot pressing has stuck to the SUS plate or the main part of the pressing machine or not was visually examined and judged after the completion of pressing.

◯: No sticking was observed.

Δ: Slight sticking was observed.

X: Sticking was observed.

### (2) Peel Strength:

The peel strength (N/cm) of the obtained flexible double-sided copper-clad laminate was measured according to JIS C6481.

### (3) Resistance to Soldering Heat:

After the obtained flexible double-sided copper-clad laminate was floated on a solder bath kept at 260° C. for 10 seconds so that the copper foil side was brought into contact with the solder bath and cooled to room temperature, the presence or absence of blister, separation, or the like was visually examined to judge the quality.

### (4) Exudation of Resin:

After completion of the pressing of the flexible double-sided copper-clad laminate of a predetermined size, the quantity of exudation of the polyimide resin from end portions of the laminate was visually examined and judged.

⊚: No exudation was observed.

◯: Slight exudation was observed.

X: A large quantity of exudation was observed.

### Comparative Example 1

Since a commercially available polyimide resin film (Kapton H manufactured by Du Pont-Toray Co., Ltd.) which was manufactured not by extrusion molding but by the casting method is not possessed of thermoplasticity, it did not exhibit the flowability under the conditions for preparing a flexible circuit board (pressing conditions) of Example 1, and thus it could not be bonded to a copper foil.

Similarly, it could not be bonded to a copper foil at the temperature of not less than 400° C.

### Comparative Example 2

Although a polyethylenenaphthalate film produced by extrusion molding exhibited slight flowability under the conditions for preparing a flexible circuit board (pressing conditions) of Example 1, but it could not be bonded to a copper foil.

### Example 6

The thermoplastic PI films “a” of 15 μm thickness and Copper foils of 18 μm thickness were superposed on both sides of a PI film (Kapton 200H manufactured by Du Pont-Toray Co., Ltd.) of 50 μm thickness, respectively. They were sandwiched between SUS plates from both sides. Further, two sheets of Fujilon STM as a cushioning material were respectively superposed on outer opposite sides of the SUS plates, and they were set in a vacuum hot pressing machine manufactured by KITAGAWA SEIKI Co., Ltd. Thereafter, the inside pressure of the pressing machine was reduced to 1.0 kPa, the temperature was increased to 300° C. at the rate of temperature increase of 5° C./min. under pressure of the initial pressure of 10 kgf/cm², then the pressure was raised to the secondary-forming pressure of 25 kgf/cm², and this state was held for 10 minutes. Thereafter, the pressing machine was cooled slowly to room temperature to obtain a flexible double-sided copper-clad laminate as shown in FIG. 3. The obtained copper-clad laminate was used to evaluate various characteristics as shown in Table 2. The results are shown in Table 2 collectively.

### Example 7

A flexible double-sided copper-clad laminate aimed at was obtained by faithfully following the procedure of Example 6 except that the pressing temperature was changed to 330° C. The obtained copper-clad laminate was used to evaluate various characteristics. The results are shown in Table 2.

### Example 8

A flexible double-sided copper-clad laminate aimed at was obtained by faithfully following the procedure of Example 6 except that the pressing temperature was changed to 360° C. The obtained copper-clad laminate was used to evaluate various characteristics. The results are shown in Table 2.

TABLE 2

| Pressing conditions and | | Examples | | |
|---|---|---|---|---|
| Characteristics | | 6 | 7 | 8 |
| Pressing Temperature | | 300 | 330 | 360 |
| (° C.) | | | | |
| Cushioning Material | | PBO | PBO | PBO |
| Sticking of Cushioning | | ◯ | ◯ | ◯ |
| Material | | | | |
| Peel | PI Film - | Impossible | Impossible to | Impossible to |
| Strength | Thermoplastic | to | measure* | measure* |
| (N/cm) | PI Film “a” | measure* | (material | (material |
| | | (material | breakage) | breakage) |
| | | breakage) | | |
| | Thermoplastic | 14 | 14 | 13 |
| | PI Film “a” - | | | |
| | Copper Foil | | | |

| | | | |
|---|---|---|---|
| Resistance to Soldering | Good | Good | Good |
| Heat | | | |
| Exudation of Resin | ⊚ | ◯ | ◯ |

Remarks
PBO: polybenzoxazol (trade name “Fujilon STM” manufactured by FUJICO Co., Ltd.)
*Material breakage: Since the bond strength is unduly high, peeling at the interface could not be performed in the peel test, which resulted in breakage.

As being clear from the results shown in Table 2, when the thermoplastic PI film of the present invention was used, the sticking of the cushioning material and the exudation of resin were not generated, the adhesiveness of the film to the copper foil was excellent so as to exhibit high peel strength, and the resistance to soldering heat was also good, in any cases of the pressing temperatures of 330° C.-360° C.

Incidentally, when the evaluation was carried out by faithfully following the procedure of Example 6 except that the pressing temperature was changed to 250° C., the peel strength was considerably low and the resistance to soldering heat was also not good, though there was no problem about the sticking of the cushioning material and the exudation of resin. Accordingly, the pressing temperature is desired to be not less than 300° C. On the other hand, when the pressing temperature was changed to 400° C., the exudation of resin was observed, though there was no problem about other various characteristics like Example 6. Accordingly, in the case of the used thermoplastic PI film, it is desirable that the pressing temperature should be less than 400° C.

### Example 9

Two-layer flexible polyimide double-sided boards having conductor circuits formed on both sides thereof were respectively superposed on both sides of the thermoplastic PI film “a” of 50 μm thickness. They were sandwiched between SUS plates from both sides. Further, two sheets of Fujilon STM as a cushioning material were respectively superposed on outer opposite sides of the SUS plates, and they were set in a vacuum hot pressing machine manufactured by KITAGAWA SEIKI Co., Ltd. Thereafter, the inside pressure of the pressing machine was reduced to 1.0 kPa, the temperature was increased to 360° C. at the rate of temperature increase of 5° C./min. under pressure of the initial pressure of 10 kgf/cm², then the pressure was raised to the secondary-forming pressure of 25 kgf/cm², and this state was held for 10 minutes. Thereafter, the pressing machine was cooled slowly to room temperature to obtain a multi-layer flexible double-sided copper-clad laminate in which the conductor circuit layers are embedded in the thermoplastic PI film, as shown in FIG. 4. The obtained copper-clad laminate was used to evaluate various characteristics as shown in Table 3. The results are shown in Table 3 collectively.

### Example 10

A multi-layer flexible double-sided copper-clad laminate aimed at was obtained by faithfully following the procedure of Example 9 except that the pressing temperature was changed to 330° C. The obtained copper-clad laminate was used to evaluate various characteristics. The results are shown in Table 3.

### Example 11

A multi-layer flexible double-sided copper-clad laminate aimed at was obtained by faithfully following the procedure of Example 9 except that the pressing temperature was changed to 360° C. The obtained copper-clad laminate was used to evaluate various characteristics. The results are shown in Table 3.

TABLE 3

| Pressing conditions and | | Examples | | |
|---|---|---|---|---|
| Characteristics | | 9 | 10 | 11 |
| Pressing Temperature | | 300 | 330 | 360 |
| (° C.) | | | | |
| Cushioning Material | | PBO | PBO | PBO |
| Sticking of Cushioning | | ◯ | ◯ | ◯ |
| Material | | | | |
| Peel | PI Film - | Impossible | Impossible to | Impossible to |
| Strength | Thermoplastic | to | measure* | measure* |
| (N/cm) | PI Film “a” | measure* | (material | (material |
| | | (material | breakage) | breakage) |
| | | breakage) | | |
| | Thermoplastic | 14 | 14 | 13 |
| | PI Film “a” - | | | |
| | Conductor | | | |
| | Circuit Layer | | | |

| | | | |
|---|---|---|---|
| Circuit Embedding | Good | Good | Good |
| Property | | | |
| Resistance to Soldering | Good | Good | Good |
| Heat | | | |
| Exudation of Resin | ⊚ | ◯ | ◯ |

Remarks
PBO: polybenzoxazol (trade name “Fujilon STM” manufactured by FUJICO Co., Ltd.)
*Material breakage: Since the bond strength is unduly high, peeling at the interface could not be performed in the peel test, which resulted in breakage.

As being clear from the results shown in Table 3, when the thermoplastic PI film of the present invention was used, the sticking of the cushioning material and the exudation of resin were not generated, the circuit embedding property and the resistance to soldering heat were also good, and the adhesiveness of the film to the conductor circuit layers was excellent so as to exhibit high peel strength, in any cases of the pressing temperatures of 330° C.-360° C.

Incidentally, when the evaluation was carried out by faithfully following the procedure of Example 9 except that the pressing temperature was changed to 250° C., the peel strength was considerably low, and the circuit embedding property and the resistance to soldering heat were also not good, though there was no problem about the sticking of the cushioning material and the exudation of resin. Accordingly, the pressing temperature is desired to be not less than 300° C. On the other hand, when the pressing temperature was changed to 400° C., the exudation of resin was observed, though there was no problem about other various characteristics like Example 9. Accordingly, in the case of the used thermoplastic PI film, it is desirable that the pressing temperature should be less than 400° C.

The circuit embedding property shown in Table 3 mentioned above was evaluated as follows (this holds good for Table 4 described hereinafter).

### (5) Circuit Embedding Property:

The produced multi-layer flexible double-sided copper-clad laminate was cross-sectioned, and the embedding quality of the resin between circuits was examined with a light microscope to judge the quality.

### Example 12

The thermoplastic PI films “a” of 50 μm thickness and Copper foils of 18 μm thickness were superposed on both sides of a two-layer flexible polyimide double-sided board having conductor circuits formed on both sides thereof, respectively. They were sandwiched between SUS plates from both sides. Further, two sheets of Fujilon STM as a cushioning material were respectively superposed on outer opposite sides of the SUS plates, and they were set in a vacuum hot pressing machine manufactured by KITAGAWA SEIKI Co., Ltd. Thereafter, the inside pressure of the pressing machine was reduced to 10 kgf/cm², the temperature was increased to 360° C. at the rate of temperature increase of 5° C./min. under pressure of the initial pressure of 1.0 MPa, then the pressure was raised to the secondary-forming pressure of 25 kgf/cm², and this state was held for 10 minutes. Thereafter, the pressing machine was cooled slowly to room temperature to obtain a flexible double-sided copper-clad laminate in which the conductor circuit layers are embedded in the thermoplastic PI films “a”, as shown in FIG. 5. The obtained copper-clad laminate was used to evaluate various characteristics as shown in Table 4. The results are shown in Table 4 collectively.

### Example 13

A flexible double-sided copper-clad laminate aimed at was obtained by faithfully following the procedure of Example 12 except that the pressing temperature was changed to 330° C. The obtained copper-clad laminate was used to evaluate various characteristics. The results are shown in Table 4.

### Example 14

A flexible double-sided copper-clad laminate aimed at was obtained by faithfully following the procedure of Example 12 except that the pressing temperature was changed to 360° C. The obtained copper-clad laminate was used to evaluate various characteristics. The results are shown in Table 4.

TABLE 4

| Pressing conditions and | | Examples | | |
|---|---|---|---|---|
| Characteristics | | 12 | 13 | 14 |
| Pressing Temperature | | 300 | 330 | 360 |
| (° C.) | | | | |
| Cushioning Material | | PBO | PBO | PBO |
| Sticking of Cushioning | | ◯ | ◯ | ◯ |
| Material | | | | |
| Peel | PI Film - | Impossible | Impossible to | Impossible to |
| Strength | Thermoplastic | to | measure* | measure* |
| (N/cm) | PI Film “a” | measure* | (material | (material |
| | | (material | breakage) | breakage) |
| | | breakage) | | |
| | Thermoplastic | 14 | 13 | 13 |
| | PI Film “a” - | | | |
| | Conductor | | | |
| | Circuit Layer | | | |

| | | | |
|---|---|---|---|
| Circuit Embedding | Good | Good | Good |
| Property | | | |
| Resistance to Soldering | Good | Good | Good |
| Heat | | | |
| Exudation of Resin | ⊚ | ◯ | ◯ |

Remarks
PBO: polybenzoxazol (trade name “Fujilon STM” manufactured by FUJICO Co., Ltd.)
*Material breakage: Since the bond strength is unduly high, peeling at the interface could not be performed in the peel test, which resulted in breakage.

As being clear from the results shown in Table 4, when the thermoplastic PI film of the present invention was used, the sticking of the cushioning material and the exudation of resin were not generated, the circuit embedding property and the resistance to soldering heat were also good, and the adhesiveness of the film to the conductor circuit layer was excellent so as to exhibit high peel strength, in any cases of the pressing temperatures of 330° C.-360° C.

Incidentally, when the evaluation was carried out by faithfully following the procedure of Example 12 except that the pressing temperature was changed to 250° C., the peel strength was considerably low, and the circuit embedding property and the resistance to soldering heat were also not good, though there was no problem about the sticking of the cushioning material and the exudation of resin. Accordingly, the pressing temperature is desired to be not less than 300° C. On the other hand, when the pressing temperature was changed to 400° C., the exudation of resin was observed, though there was no problem about other various characteristics like Example 12. Accordingly, in the case of the used thermoplastic PI film, it is desirable that the pressing temperature should be less than 400° C.

### Example 15

A flexible double-sided copper-clad laminate aimed at was obtained by faithfully following the procedure of Example 1 except that the thermoplastic polyimide resin film “a” was changed to the thermoplastic PI film “b”. The obtained copper-clad laminate was used to evaluate various characteristics as shown in Table 5. The results are shown in Table 5 collectively.

### Example 16

A flexible double-sided copper-clad laminate aimed at was obtained by faithfully following the procedure of Example 15 except that the pressing temperature was changed to 330° C. The obtained copper-clad laminate was used to evaluate various characteristics. The results are shown in Table 5.

### Example 17

A flexible double-sided copper-clad laminate aimed at was obtained by faithfully following the procedure of Example 15 except that the pressing temperature was changed to 360° C. The obtained copper-clad laminate was used to evaluate various characteristics. The results are shown in Table 5.

### Example 18

A flexible double-sided copper-clad laminate aimed at was obtained by faithfully following the procedure of Example 15 except that the pressing temperature was changed to 380° C. The obtained copper-clad laminate was used to evaluate various characteristics. The results are shown in Table 5.

### Example 19

A flexible double-sided copper-clad laminate aimed at was obtained by faithfully following the procedure of Example 15 except that the pressing temperature was changed to 330° C. or 380° C. and the cushioning material was changed to P-aramid (aromatic polyamide available under the trade name of “Fujilon 9000” from FUJICO Co., Ltd.). The obtained copper-clad laminate was used to evaluate various characteristics. The results are shown in Table 5.

TABLE 5

| Pressing conditions and | | Examples | | | | | |
|---|---|---|---|---|---|---|---|
| Characteristics | | 15 | 16 | 17 | 18 | 19 | |
| Pressing Temperature | | 300 | 330 | 360 | 380 | 330 | 380 |
| (° C.) | | | | | | | |
| Cushioning Material | | PBO | PBO | PBO | PBO | P-aramid | |
| Sticking of Cushioning | | ◯ | ◯ | ◯ | ◯ | ◯ | Δ |
| Material | | | | | | | |
| Peel | Thermoplastic | 13 | 13 | 14 | 14 | 13 | 14 |
| Strength | PI Film “b” - | | | | | | |
| (N/cm) | Copper Foil | | | | | | |

| | | | | | | |
|---|---|---|---|---|---|---|
| Resistance to Soldering | Good | Good | Good | Good | Good | Good |
| Heat | | | | | | |
| Exudation of Resin | ⊚ | ◯ | ◯ | ◯ | ◯ | ◯ |

Remarks
PBO: polybenzoxazol (trade name “Fujilon STM” manufactured by FUJICO Co., Ltd.)
P-aramid: aromatic polyamide (trade name “Fujilon 9000” manufactured by FUJICO Co., Ltd.

As being clear from the results shown in Table 5, even when the thermoplastic PI film “b” was used, the sticking of the cushioning material and the exudation of resin were not generated, the adhesiveness of the film to the copper foil was excellent so as to exhibit high peel strength, and the resistance to soldering heat was also good, in any cases of the pressing temperatures of 330-380° C.

### Oriented Film Production Example 1:

A pelletized resin material of a thermoplastic polyimide having the chemical constitutional formula represented by the aforementioned formula (6) (AURUM (registered trademark) PD450C manufactured by Mitsui Chemicals, Inc.; Tg: 250 [° C.], melting point: 388 [° C.], melt viscosity measured at the shear rate of 500 sec⁻¹:500 [Pa·S]) was dried to remove absorbed water, and then melted by heating with a single screw extruder. The molten resin discharged in the shape of a flat film from a T-die provided at a leading end of the extruder is cooled and solidified by being brought into contact with a cooling roll to obtain a thermoplastic polyimide resin (hereinafter referred to occasionally as TPI) film (A).

The resultant thermoplastic polyimide resin film (A) was heated to 260° C., stretched in two directions perpendicularly intersecting each other by 3 times the original size. The resultant oriented film was heat-set at 300° C. under stretching to obtain a biaxially oriented thermoplastic polyimide resin film (A-3) aimed at. Further, a biaxially oriented thermoplastic polyimide resin film (A-2) was produced by the same operation as mentioned above except that the film was stretched by 2 times the original size. Incidentally, “−3” of the symbol (A-3) and “−2” of the symbol (A-2) were attached so as to be easily understood that they mean 3 times stretching and 2 times stretching, respectively. This holds good for the same expression to be described hereinafter.

### Oriented Film Production Example 2:

A thermoplastic polyimide resin film (B) was obtained in the same manner as the film production process described in Oriented Film Production Example 1 mentioned above except that a pelletized resin material of a thermoplastic polyimide containing the chemical constitutional formulas represented by the aforementioned formulas (6) and (7) in the ratio of 9:1 (AURUM (registered trademark) PD500A manufactured by Mitsui Chemicals, Inc.; Tg: 258 [° C.], melting point: 380 [° C.], melt viscosity measured at the shear rate of 500 sec⁻¹:700 [Pa·S]) was used.

The resultant thermoplastic polyimide resin film (B) was heated to 260° C., stretched in two directions perpendicularly intersecting each other by 3 times the original size. The resultant oriented film was heat-set at 300° C. under stretching to obtain a biaxially oriented thermoplastic polyimide resin film (B-3) aimed at.

### Oriented Film Production Example 3:

A thermoplastic polyimide resin film (C) was obtained in the same manner as the film production process described in Oriented Film Production Example 1 mentioned above except that a pelletized resin material of a blend of a thermoplastic polyimide having the chemical constitutional formula represented by the aforementioned formula (6) (AURUM (registered trademark) PD450C manufactured by Mitsui Chemicals, Inc.) and a polyether ether ketone resin (trade name “450P” manufactured by Victrex-MC, Inc.) in the ratio of 80:20 was used.

The resultant thermoplastic polyimide resin film (C) was heated to 260° C., stretched in two directions perpendicularly intersecting each other by 3 times the original size. The resultant oriented film was heat-set at 300° C. under stretching to obtain a biaxially oriented thermoplastic polyimide resin film (C-3) aimed at.

### Oriented Film Production Example 4:

Both sides of the biaxially oriented thermoplastic polyimide resin film (A-3) produced according to Oriented Film Production Example 1 mentioned above was subjected to a corona discharge treatment to obtain a biaxially oriented thermoplastic polyimide resin film (D-3) aimed at. Incidentally, the corona discharge treatment of the film surface was performed under the conditions of watt density 120 W/m² per one minute using a corona treatment device manufactured by Tomoe Engineering Co., Ltd.

### Oriented Film Production Example 5:

A thermoplastic polyimide resin film (A) was obtained in the same manner as the film production process described in Oriented Film Production Example 1 mentioned above except that a pelletized resin material of the thermoplastic polyimide having the chemical constitutional formula represented by the aforementioned formula (6) (AURUM (registered trademark) PD450C manufactured by Mitsui Chemicals, Inc.) was used.

The resultant thermoplastic polyimide resin film (A) was heated to 280° C., stretched in two directions perpendicularly intersecting each other by 3 times the original size. The resultant oriented film was heat-set at 310° C. under stretching to obtain a biaxially oriented thermoplastic polyimide resin film (E-3) aimed at.

### Oriented Film Production Example 6:

A thermoplastic polyimide resin film (A) was obtained in the same manner as the film production process described in Oriented Film Production Example 1 mentioned above except that a pelletized resin material of the thermoplastic polyimide having the chemical constitutional formula represented by the aforementioned formula (6) (AURUM (registered trademark) PD450C manufactured by Mitsui Chemicals, Inc.) was used.

The resultant thermoplastic polyimide resin film (A) was heated to 260° C., stretched in only one direction by 3 times the original size. The resultant oriented film was heat-set at 300° C. under stretching to obtain a uniaxially oriented thermoplastic polyimide resin film (F-3) aimed at.

The thermal expansion coefficients α₂₀₋₂₀₀ of the oriented thermoplastic polyimide resin films obtained in Oriented Film Production Examples 1-6 mentioned above and the glass transition temperatures (Tg) of the unoriented or oriented thermoplastic polyimide resin films are collectively shown in Table 6. Further, the data of the unoriented thermoplastic polyimide resin film (A) are also collectively shown therein for reference. Incidentally, as the thermal expansion coefficient, the linear expansion coefficient (CTE) measured by the following method was used from the viewpoint of the two-dimensional shape of the film. The glass transition temperature (Tg) was determined according to the thermomechanical analysis (TMA) by the following measuring method.

### <Linear Expansion Coefficient (CTE)>

The thermal expansion coefficient in the range of 20-200° C. was measured at the rate of temperature increase of 5° C./min. under the tensile load of 5 gf by use of a test piece of 2×23 mm and the thermomechanical measuring equipment TMA-60 manufactured by Shimadzu Corporation.

### <Tg According to TMA Measuring Method>

The glass transition temperature Tg was measured according to the method specified in “5.17.1 TMA method” of JIS C 6481:1996 at the rate of temperature increase of 5° C./min. under the tensile load of 5 gf by use of a test piece of 2×23 mm and the thermomechanical measuring equipment TMA-60 manufactured by Shimadzu Corporation.

TABLE 6

| | | Oriented Film Thermoplastic Polyimide Resin | | | | | | | |
|---|---|---|---|---|---|---|---|---|---|
| Characteristics | | A-3*¹ | A-2*¹ | B-3*¹ | C-3*¹ | D-3*¹ | E-3*¹ | F-3*² | A*³ |
| CTE | MD | 15 | 40 | 21 | 29 | 15 | 45 | 28 | 55 |
| (ppm) | Direction | | | | | | | | |
| | TD | 18 | 40 | 23 | 29 | 18 | 45 | 60 | 55 |
| | Direction | | | | | | | | |

| | | | | | | | | |
|---|---|---|---|---|---|---|---|---|
| Tg measured by | 250 | 250 | 258 | 250 | 250 | 250 | 250 | 250 |
| TMA before | | | | | | | | |
| orientation (° C.) | | | | | | | | |
| Tg measured by | 320 | 320 | 305 | 320 | 320 | 320 | 305 | — |
| TMA after | | | | | | | | |
| orientation (° C.) | | | | | | | | |
| Increase in Tg | 70 | 70 | 47 | 70 | 70 | 70 | 55 | — |
| measured by TMA | | | | | | | | |
| after orientation | | | | | | | | |
| (° C.) | | | | | | | | |

Remarks
*¹Biaxial orientation
*²Uniaxial orientation
*³Unoriented

### Example 20

A copper (hereinafter abbreviated occasionally as “Cu”) foil of 18 μm thickness was superposed on one side of the 12.5 μm-thick biaxially oriented thermoplastic polyimide resin film (A-3) obtained in Oriented Film Production Example 1. They were sandwiched between SUS plates through the medium of 100 μm-thick polytetrafluoroethylene (hereinafter referred to as “PTFE”) films as a release film from both sides. Further, two sheets of Fujilon STM manufactured by FUJICO Co., Ltd. as a felt-like cushioning material made of polybenzoxazol were respectively superposed on outer opposite sides of the SUS plates, and they were set in a vacuum hot pressing machine manufactured by KITAGAWA SEIKI Co., Ltd. Thereafter, the inside pressure of the pressing machine was reduced to 1.0 kPa, the temperature was increased to 360° C. at the rate of temperature increase of 5° C./min. under pressure of the initial pressure of 10 kgf/cm², then the pressure was raised to the secondary-forming pressure of 25 kgf/cm², and this state was held for 10 minutes. Thereafter, the pressing machine was cooled slowly to room temperature to obtain a flexible single-sided copper-clad laminate of the layer construction of TPI/Cu.

### Example 21

A flexible single-sided copper-clad laminate of the layer construction of TPI/Cu aimed at was obtained by faithfully following the procedure of Example 20 except that the biaxially oriented thermoplastic polyimide resin film (A-3) was changed to the biaxially oriented thermoplastic polyimide resin film (B-3) obtained in Oriented Film Production Example 2.

### Example 22

A flexible single-sided copper-clad laminate of the layer construction of TPI/Cu aimed at was obtained by faithfully following the procedure of Example 20 except that the biaxially oriented thermoplastic polyimide resin film (A-3) was changed to the biaxially oriented thermoplastic polyimide resin film (C-3) obtained in Oriented Film Production Example 3.

The flexible single-sided copper-clad laminates obtained in Examples 20-22 mentioned above were used to evaluate various characteristics. The results are shown in Table 7 collectively.

TABLE 7

| | | Examples | | |
|---|---|---|---|---|
| Characteristics | | 20 | 21 | 22 |
| Oriented Thermoplastic | | A-3 | B-3 | C-3 |
| Polyimide Resin Film | | | | |
| Pressing Temperature | | 360 | 360 | 360 |
| (° C.) | | | | |
| Cushioning Material | | PBO | PBO | PBO |
| Bond | TPI Film - | ◯ | ◯ | ◯ |
| Strength | Copper Foil | | | |
| (N/mm) | | | | |

| | | | |
|---|---|---|---|
| Warp after Bonding | ◯ | ◯ | ◯ |
| Resistance to | ◯ | ◯ | ◯ |
| Solder reflow | | | |

Remarks
PBO: polybenzoxazol (trade name “Fujilon STM” manufactured by FUJICO Co., Ltd.)

The bond strength, the warp after bonding, and the resistance to solder reflow shown in Table 7 mentioned above were evaluated as follows. This holds good for the examples to be described hereinafter.

### (1) Bond Strength:

The bond strength of the obtained flexible copper-clad laminate was evaluated based on the following criterion by measuring the peel strength (N/mm) according to JIS C6481.

◯: >0.8 N/mm

Δ: 0.4-0.8 N/mm

X: <0.4 N/mm

(2) Warp after Bonding:

After completion of pressing, the presence or absence of warp in the obtained flexible copper-clad laminate was visually examined and judged based on the following criterion.

◯: No warp was observed.

Δ: Slight warp was observed.

X: Curling was observed.

### (3) Resistance to Solder Reflow:

After the obtained flexible copper-clad laminate was passed through a reflow furnace set to the maximum attainable temperature of 260° C., the presence or absence of blister or warp was visually examined. The criterion for judgment is as follows.

◯: Blister and warp were not observed.

Δ: Slight blister and warp were observed.

X: Blister and curling were observed.

### Example 23

A flexible single-sided copper-clad laminate of the layer construction of TPI/Cu aimed at was obtained by faithfully following the procedure of Example 20 except that the biaxially oriented thermoplastic polyimide resin film (A-3) was changed to the biaxially oriented thermoplastic polyimide resin film (A-2). Since the linear expansion coefficient of the resin film was unduly high, warp occurred after bonding to the copper foil.

### Example 24

A flexible single-sided copper-clad laminate of the layer construction of TPI/Cu aimed at was obtained by faithfully following the procedure of Example 20 except that the pressing temperature was changed to 280° C. As the result, since the pressing temperature was lower than the softening starting temperature of the A-3 film, the bond strength was lower than those of other examples.

### Example 25

A flexible single-sided copper-clad laminate of the layer construction of TPI/Cu aimed at was obtained by faithfully following the procedure of Example 20 except that the pressing temperature was changed to 390° C. As the result, since the pressing was carried out at a temperature exceeding the melting point of the film, the flow out of resin occurred, and the linear expansion coefficient was increased.

### Example 26

A flexible single-sided copper-clad laminate of the layer construction of TPI/Cu aimed at was obtained by faithfully following the procedure of Example 20 except that the cushioning material was not used. As the result, since the cushioning material was not used, the high surface smoothness of the film was not attained.

### Example 27

A flexible single-sided copper-clad laminate of the layer construction of TPI/Cu aimed at was obtained by faithfully following the procedure of Example 20 except that the biaxially oriented thermoplastic polyimide resin film (A-3) was changed to the biaxially oriented thermoplastic polyimide resin film (D-3).

### Example 28

A flexible single-sided copper-clad laminate of the layer construction of TPI/Cu aimed at was obtained by faithfully following the procedure of Example 20 except that the biaxially oriented thermoplastic polyimide resin film (A-3) was changed to the biaxially oriented thermoplastic polyimide resin film (E-3). Since the linear expansion coefficient of the resin film was unduly high, warp occurred after bonding to the copper foil.

The flexible single-sided copper-clad laminates obtained in Examples 23-28 mentioned above were used to evaluate various characteristics. The results are shown in Table 8 collectively.

TABLE 8

| | | Examples | | | | | |
|---|---|---|---|---|---|---|---|
| Characteristics | | 23 | 24 | 25 | 26 | 27 | 28 |
| Oriented Thermoplastic | | A-2 | A-3 | A-3 | A-3 | D-3 | E-3 |
| Polyimide Resin Film | | | | | | | |
| Pressing Temperature | | 360 | 280 | 390 | 360 | 360 | 360 |
| (° C.) | | | | | | | |
| Cushioning Material | | PBO | PBO | PBO | None | PBO | PBO |
| Bond | TPI Film - | ◯ | Δ | ◯ | ◯ | ◯ | ◯ |
| Strength | Copper Foil | | | | | | |
| (N/cm) | | | | | | | |

| | | | | | | |
|---|---|---|---|---|---|---|
| Warp after Bonding | Δ | ◯ | ◯ | ◯ | ◯ | Δ |
| Resistance to | Δ | ◯ | ◯ | ◯ | ◯ | Δ |
| Solder reflow | | | | | | |

Remarks
PBO: polybenzoxazol (trade name “Fujilon STM” manufactured by FUJICO Co., Ltd.)

### Example 29

Copper foils of 18 μm thickness were superposed on both sides of the 12.5 μm-thick biaxially oriented thermoplastic polyimide resin film (A-3). They were sandwiched between SUS plates through the medium of 100 μm-thick PTFE films as a release film from both sides. Further, two sheets of Fujilon STM as a felt-like cushioning material made of polybenzoxazol were respectively superposed on outer opposite sides of the SUS plates, and they were set in a vacuum hot pressing machine manufactured by KITAGAWA SEIKI Co., Ltd. Thereafter, the inside pressure of the pressing machine was reduced to 1.0 kPa, the temperature was increased to 360° C. at the rate of temperature increase of 5° C./min. under pressure of the initial pressure of 10 kgf/cm², then the pressure was raised to the secondary-forming pressure of 25 kgf/cm², and this state was held for 10 minutes. Thereafter, the pressing machine was cooled slowly to room temperature to obtain a flexible double-sided copper-clad laminate of the layer construction of Cu/TPI/Cu.

### Example 30

A flexible double-sided copper-clad laminate of the layer construction of Cu/TPI/Cu aimed at was obtained by faithfully following the procedure of Example 29 except that the biaxially oriented thermoplastic polyimide resin film (A-3) was changed to the biaxially oriented thermoplastic polyimide resin film (B-3).

### Example 31

A flexible double-sided copper-clad laminate of the layer construction of Cu/TPI/Cu aimed at was obtained by faithfully following the procedure of Example 29 except that the biaxially oriented thermoplastic polyimide resin film (A-3) was changed to the biaxially oriented thermoplastic polyimide resin film (C-3).

The flexible double-sided copper-clad laminates obtained in Examples 29-31 mentioned above were used to evaluate various characteristics. The results are shown in Table 9 collectively.

TABLE 9

| | | Examples | | |
|---|---|---|---|---|
| Characteristics | | 29 | 30 | 31 |
| Oriented Thermoplastic | | A-3 | B-3 | C-3 |
| Polyimide Resin Film | | | | |
| Pressing Temperature | | 360 | 360 | 360 |
| (° C.) | | | | |
| Cushioning Material | | PBO | PBO | PBO |
| Bond | TPI Film - | ◯ | ◯ | ◯ |
| Strength | Copper Foil | | | |
| (N/mm) | | | | |

| | | | |
|---|---|---|---|
| Warp after Bonding | ◯ | ◯ | ◯ |
| Resistance to | ◯ | ◯ | ◯ |
| Solder reflow | | | |

Remarks
PBO: polybenzoxazol (trade name “Fujilon STM” manufactured by FUJICO Co., Ltd.)

### Example 32

12.5 μm-thick biaxially oriented thermoplastic polyimide resin films (A-3) were superposed on both sides of 50 μm-thick Kapton EN (polyimide resin film manufactured by Du Pont-Toray Co., Ltd.; since this polyimide resin is a straight-chain polymer which does not exhibit thermoplasticity (thermal reversibility between hardening and softening) and cannot be extrusion-molded if it is used independently, this commercially available polyimide resin (hereinafter referred to as “PI”) film is that obtained by casting a solution containing a polyamic acid of a precursor on a roll or a flat surface and then carrying out a dehydrating condensation reaction), and further copper foils of 18 μm thickness were superposed on outer opposite sides thereof. They were sandwiched between SUS plates through the medium of 100 μm-thick PTFE films as a release film from both sides. Further, two sheets of Fujilon STM as a felt-like cushioning material made of polybenzoxazol were respectively superposed on outer opposite sides of the SUS plates, and they were set in a vacuum hot pressing machine manufactured by KITAGAWA SEIKI Co., Ltd. Thereafter, the inside pressure of the pressing machine was reduced to 1.0 kPa, the temperature was increased to 360° C. at the rate of temperature increase of 5° C./min. under pressure of the initial pressure of 10 kgf/cm², then the pressure was raised to the secondary-forming pressure of 25 kgf/cm², and this state was held for 10 minutes. Thereafter, the pressing machine was cooled slowly to room temperature to obtain a flexible double-sided copper-clad laminate of the layer construction of Cu/TPI/PI/TPI/Cu.

### Example 33

A flexible double-sided copper-clad laminate of the layer construction of Cu/TPI/PI/TPI/Cu aimed at was obtained by faithfully following the procedure of Example 32 except that the biaxially oriented thermoplastic polyimide resin film (A-3) was changed to the biaxially oriented thermoplastic polyimide resin film (B-3).

### Example 34

A flexible double-sided copper-clad laminate of the layer construction of Cu/TPI/PI/TPI/Cu aimed at was obtained by faithfully following the procedure of Example 32 except that the biaxially oriented thermoplastic polyimide resin film (A-3) was changed to the biaxially oriented thermoplastic polyimide resin film (C-3).

The flexible double-sided copper-clad laminates obtained in Examples 32-34 mentioned above were used to evaluate various characteristics. The results are shown in Table 10 collectively.

TABLE 10

| | | Examples | | |
|---|---|---|---|---|
| Characteristics | | 32 | 33 | 34 |
| Oriented Thermoplastic | | A-3 | B-3 | C-3 |
| Polyimide Resin Film | | | | |
| Pressing Temperature | | 360 | 360 | 360 |
| (° C.) | | | | |
| Cushioning Material | | PBO | PBO | PBO |
| Bond | TPI Film - | ◯ | ◯ | ◯ |
| Strength | Copper Foil | | | |
| (N/mm) | TPI Film - | ◯ | ◯ | ◯ |
| | PI Film | | | |

| | | | |
|---|---|---|---|
| Warp after Bonding | ◯ | ◯ | ◯ |
| Resistance to | ◯ | ◯ | ◯ |
| Solder reflow | | | |

Remarks
PBO: polybenzoxazol (trade name “Fujilon STM” manufactured by FUJICO Co., Ltd.)

### Example 35

Two-layer flexible polyimide double-sided boards having conductor circuits formed on both sides thereof were respectively superposed on both sides of 12.5 μm-thick biaxially oriented thermoplastic polyimide resin films (A-3). They were sandwiched between SUS plates through the medium of 100 μm-thick PTFE films as a release film from both sides. Further, two sheets of Fujilon STM as a cushioning material were respectively superposed on outer opposite sides of the SUS plates, and they were set in a vacuum hot pressing machine manufactured by KITAGAWA SEIKI Co., Ltd. Thereafter, the inside pressure of the pressing machine was reduced to 1.0 kPa, the temperature was increased to 360° C. at the rate of temperature increase of 5° C./min. under pressure of the initial pressure of 10 kgf/cm², then the pressure was raised to the secondary-forming pressure of 25 kgf/cm², and this state was held for 10 minutes. Thereafter, the pressing machine was cooled slowly to room temperature to obtain a multi-layer flexible double-sided copper-clad laminate of the layer construction of conductor circuit/PI/conductor circuit/TPI/conductor circuit/PI/conductor circuit in which the conductor circuits are embedded in the thermoplastic polyimide resin film.

### Example 36

A multi-layer flexible double-sided copper-clad laminate of the layer construction of conductor circuit/PI/conductor circuit/TPI/conductor circuit/PI/conductor circuit aimed at was obtained by faithfully following the procedure of Example 35 except that the biaxially oriented thermoplastic polyimide resin film (A-3) was changed to the biaxially oriented thermoplastic polyimide resin film (B-3).

### Example 37

A multi-layer flexible double-sided copper-clad laminate of the layer construction of conductor circuit/PI/conductor circuit/TPI/conductor circuit/PI/conductor circuit aimed at was obtained by faithfully following the procedure of Example 35 except that the biaxially oriented thermoplastic polyimide resin film (A-3) was changed to the biaxially oriented thermoplastic polyimide resin film (C-3).

The multi-layer flexible double-sided copper-clad laminates obtained in Examples 35-37 mentioned above were used to evaluate various characteristics. The results are shown in Table 11 collectively.

TABLE 11

| | | Examples | | |
|---|---|---|---|---|
| Characteristics | | 35 | 36 | 37 |
| Oriented Thermoplastic | | A-3 | B-3 | C-3 |
| Polyimide Resin Film | | | | |
| Pressing Temperature | | 360 | 360 | 360 |
| (° C.) | | | | |
| Cushioning Material | | PBO | PBO | PBO |
| Bond | TPI Film - | ◯ | ◯ | ◯ |
| Strength | Copper Foil | | | |
| (N/mm) | TPI Film - | ◯ | ◯ | ◯ |
| | PI Film | | | |

| | | | |
|---|---|---|---|
| Warp after Bonding | ◯ | ◯ | ◯ |
| Resistance to | ◯ | ◯ | ◯ |
| Solder reflow | | | |

Remarks
PBO: polybenzoxazol (trade name “Fujilon STM” manufactured by FUJICO Co., Ltd.)

### Example 38

12.5 μm-thick biaxially oriented thermoplastic polyimide resin films (A-3) and 18 μm-thick copper foils were respectively superposed on both sides of a two-layer flexible polyimide double-sided board having conductor circuits formed on both sides thereof. They were sandwiched between SUS plates through the medium of 100 μm-thick PTFE films as a release film from both sides. Further, two sheets of Fujilon STM as a cushioning material were respectively superposed on outer opposite sides of the SUS plates, and they were set in a vacuum hot pressing machine manufactured by KITAGAWA SEIKI Co., Ltd. Thereafter, the inside pressure of the pressing machine was reduced to 10 kgf/cm², the temperature was increased to 360° C. at the rate of temperature increase of 5° C./min. under pressure of the initial pressure of 1.0 MPa, then the pressure was raised to the secondary-forming pressure of 25 kgf/cm², and this state was held for 10 minutes. Thereafter, the pressing machine was cooled slowly to room temperature to obtain a multi-layer flexible double-sided copper-clad laminate of the layer construction of Cu/TPI/conductor circuit/PI/conductor circuit/TPI/Cu in which the conductor circuits are embedded in the thermoplastic polyimide resin films.

### Example 39

A multi-layer flexible double-sided copper-clad laminate of the layer construction of Cu/TPI/conductor circuit/PI/conductor circuit/TPI/Cu aimed at was obtained by faithfully following the procedure of Example 38 except that the biaxially oriented thermoplastic polyimide resin film (A-3) was changed to the biaxially oriented thermoplastic polyimide resin film (B-3).

### Example 40

A multi-layer flexible double-sided copper-clad laminate of the layer construction of Cu/TPI/conductor circuit/PI/conductor circuit/TPI/Cu aimed at was obtained by faithfully following the procedure of Example 38 except that the biaxially oriented thermoplastic polyimide resin film (A-3) was changed to the biaxially oriented thermoplastic polyimide resin film (C-3).

The multi-layer flexible double-sided copper-clad laminates obtained in Examples 38-40 mentioned above were used to evaluate various characteristics. The results are shown in Table 12 collectively.

TABLE 12

| | | Examples | | |
|---|---|---|---|---|
| Characteristics | | 38 | 39 | 40 |
| Oriented Thermoplastic | | A-3 | B-3 | C-3 |
| Polyimide Resin Film | | | | |
| Pressing Temperature | | 360 | 360 | 360 |
| (° C.) | | | | |
| Cushioning Material | | PBO | PBO | PBO |
| Bond | TPI Film - | ◯ | ◯ | ◯ |
| Strength | Copper Foil | | | |
| (N/mm) | TPI Film - | ◯ | ◯ | ◯ |
| | PI Film | | | |

| | | | |
|---|---|---|---|
| Warp after Bonding | ◯ | ◯ | ◯ |
| Resistance to | ◯ | ◯ | ◯ |
| Solder reflow | | | |

Remarks
PBO: polybenzoxazol (trade name “Fujilon STM” manufactured by FUJICO Co., Ltd.)

### Comparative Example 3

An unoriented thermoplastic polyimide resin film (A) of 25 μm thickness was used, and a copper foil of 18 μm thickness was superposed on one side of this film. They were sandwiched between SUS plates through the medium of 100 μm-thick PTFE films as a release film from both sides. Further, two sheets of Fujilon STM as a felt-like cushioning material made of polybenzoxazol were respectively superposed on outer opposite sides of the SUS plates, and they were set in a vacuum hot pressing machine manufactured by KITAGAWA SEIKI Co., Ltd. Thereafter, the inside pressure of the pressing machine was reduced to 1.0 kPa, the temperature was increased to 360° C. at the rate of temperature increase of 5° C./min. under pressure of the initial pressure of 10 kgf/cm², then the pressure was raised to the secondary-forming pressure of 25 kgf/cm², and this state was held for 10 minutes. Thereafter, the pressing machine was cooled slowly to room temperature to obtain a flexible one-sided copper-clad laminate of the layer construction of unoriented TPI/Cu. In the obtained flexible one-sided copper-clad laminate, since the linear expansion coefficient of the unoriented thermoplastic polyimide resin film used is high, the remarkable warp (curling) occurred after bonding to the copper foil.

### Comparative Example 4

A flexible one-sided copper-clad laminate of the layer construction of uniaxially oriented TPI/Cu was obtained by faithfully following the procedure of Example 20 except that the biaxially oriented thermoplastic polyimide resin film (A-3) was changed to the uniaxially oriented thermoplastic polyimide resin film (F-3). In the obtained flexible one-sided copper-clad laminate, since the linear expansion coefficient in the TD direction (width direction of the film) of the oriented thermoplastic polyimide resin film (F-3) used is high, though the linear expansion coefficient in the MD direction (longitudinal direction of the film) is approximate to that of the copper foil, the remarkable warp (curling) occurred after bonding to the copper foil.

### Comparative Example 5

A flexible one-sided copper-clad laminate of the layer construction of TPI/Cu was obtained by faithfully following the procedure of Example 20 except that the pressing temperature was changed to 240° C. As the result, since the pressing was carried out at a temperature lower than Tg of the biaxially oriented thermoplastic polyimide resin film, the biaxially oriented thermoplastic polyimide resin film had not start softening and thus could not be bonded to the copper foil.

The flexible one-sided copper-clad laminates obtained in Comparative Examples 3-5 mentioned above were used to evaluate various characteristics. The results are shown in Table 13 collectively.

TABLE 13

| | | Comparative Examples | | |
|---|---|---|---|---|
| Characteristics | | 3 | 4 | 5 |
| Oriented Thermoplastic | | A | F-3 | A-3 |
| Polyimide Resin Film | | | | |
| Pressing Temperature | | 360 | 360 | 240 |
| (° C.) | | | | |
| Cushioning Material | | PBO | PBO | PBO |
| Bond | TPI Film - | ◯ | ◯ | X |
| Strength | Copper Foil | | | |
| (N/mm) | | | | |

| | | | |
|---|---|---|---|
| Warp after Bonding | X | X | — |
| Resistance to | — | — | — |
| Solder reflow | | | |
| State after Bonding | Remarkable | Remarkable | Failed of |
| | warp | warp | bonding |

Remarks
PBO: polybenzoxazol (trade name “Fujilon STM” manufactured by FUJICO Co., Ltd.)

Since the flexible laminate of the present invention contains a thermoplastic polyimide layer as an adhesive layer, it can be used in various technical fields, for example, as coverlay films of various flexible substrates or planar heating elements and laminating materials for metal foils of stainless steel, aluminum, nickel, or the like. Particularly, it can be advantageously used in the production of flexible printed circuit boards or in the production of tape-automated-bonding (TAB) products which can be said to be a kind of a flexible printed circuit board.

The International Application PCT/JP2007/056218, filed Mar. 26, 2007, describes the invention described hereinabove and claimed in the claims appended hereinbelow, the disclosure of which is incorporated here by reference.

What is claimed is:

1. A flexible laminate containing either one or both of a metal foil layer/a thermoplastic polyimide layer and a conductor circuit layer/a thermoplastic polyimide layer, said metal foil layer or conductor circuit layer being bonded to at least one side of the thermoplastic polyimide layer, characterized in that said thermoplastic polyimide layer is formed from a thermoplastic polyimide resin film or sheet produced by melt extrusion of a thermoplastic polyimide resin or formed from a biaxially oriented thermoplastic polyimide resin film or sheet.

2. The flexible laminate according to claim 1, wherein said thermoplastic polyimide resin has a glass transition temperature (Tg) of 180-280° C.

3. The flexible laminate according to claim 1, wherein said thermoplastic polyimide resin has a melt viscosity of 5×10¹-1×10⁴ [Pa·S] measured at a shear rate in the range of 50-500 [sec⁻¹] at an extrusion temperature higher than a melting point of said resin by 30° C.

4. The flexible laminate according to claim 1, wherein said biaxially oriented thermoplastic polyimide resin film or sheet is formed by biaxially stretching a thermoplastic polyimide resin film or sheet obtained by melt extrusion of a thermoplastic polyimide resin.

5. The flexible laminate according to claim 1, wherein said biaxially oriented thermoplastic polyimide resin film or sheet has a coefficient of thermal expansion, α₂₀₋₂₀₀, falling in the range of 5×10⁻⁶-30×10⁻⁶/K in any of a MD direction (longitudinal direction of the film) and a TD direction (width direction of the film).

6. The flexible laminate according to claim 1, wherein said biaxially oriented thermoplastic polyimide resin film or sheet has the difference in a coefficient of thermal expansion, α₂₀₋₂₀₀, between a MD direction (longitudinal direction of the film) and a TD direction (width direction of the film) of less than 20×10⁻⁶/K.

7. The flexible laminate according to claim 1, wherein said biaxially oriented thermoplastic polyimide resin film or sheet has a glass transition temperature Tg higher than a glass transition temperature Tg of an unoriented thermoplastic polyimide resin film by 10-80° C., said glass transition temperature Tg being measured by thermomechanical analysis (TMA) according to a method specified in “5.17.1 TMA method” of JIS C 6481:1996.

8. The flexible laminate according to claim 1, wherein said thermoplastic polyimide resin is a crystalline thermoplastic polyimide resin.

9. The flexible laminate according to claim 1, wherein said thermoplastic polyimide resin is a mixture of a crystalline thermoplastic polyimide resin with other thermoplastic resin having a melting point of 280-350° C.

10. The flexible laminate according to claim 1, wherein said thermoplastic polyimide resin is a thermoplastic polyimide resin having a recurring structural unit represented by the following general formula (1): 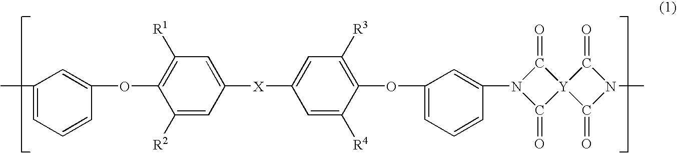
wherein, X represents a direct bond, —SO₂—, —CO—, —C(CH₃)₂—, —C(CF₃)₂—, or —S—, R¹, R², R³, and R⁴ independently represent a hydrogen atom, an alkyl group of 1-6 carbon atoms, an alkoxy group, a halogenated alkyl group, a halogenated alkoxy group, or a halogen atom, and Y represents a group selected from the group consisting of the groups represented by the following formulas (2).

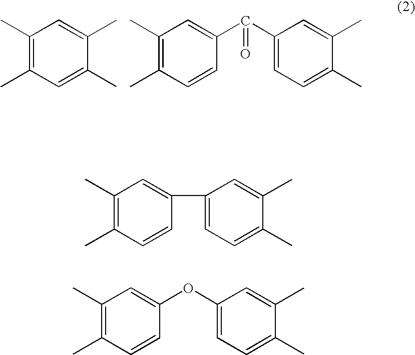

11. The flexible laminate according to claim 1, wherein said thermoplastic polyimide resin is a thermoplastic polyimide resin having a recurring structural unit represented by the following formula (5).

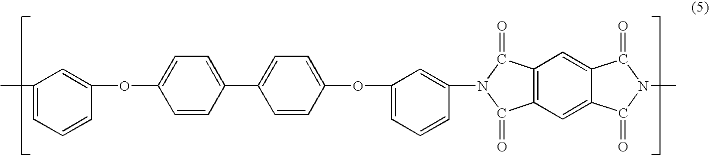

12. The flexible laminate according to claim 1, wherein said thermoplastic polyimide resin is a thermoplastic polyimide resin having recurring structural units represented by the following formulas (6) and (7): 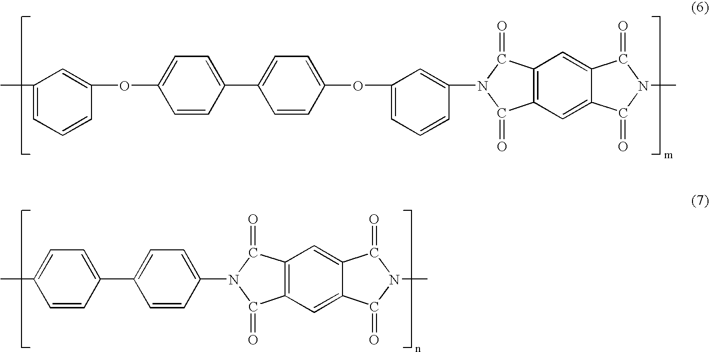
wherein, “m” and “n” represent a molar ratio of each structural unit within the range of m/n=4-9.

13. The flexible laminate according to claim 1, wherein said thermoplastic polyimide resin is a thermoplastic polyimide resin having recurring structural units represented by the following formulas (6) and (8), and a molar ratio of the recurring structural unit represented by the formula (6) to the recurring structural unit represented by the formula (8) falls in the range of 1:0 to 0.75:0.25.

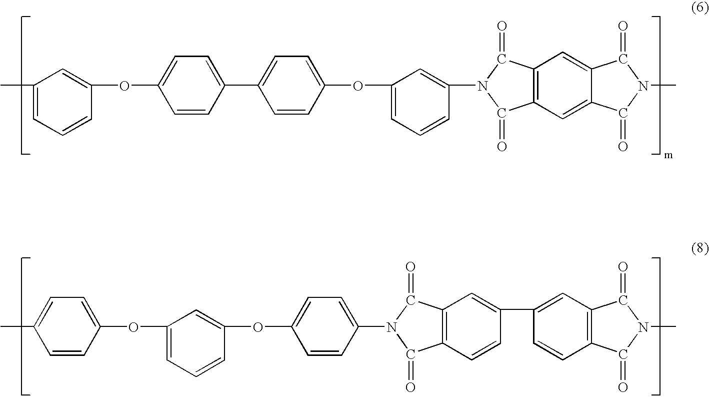

14. A method for manufacturing a flexible laminate containing either one or both of a metal foil layer/a thermoplastic polyimide layer and a conductor circuit layer/a thermoplastic polyimide layer, said metal foil or conductor circuit layer being bonded to at least one side of the thermoplastic polyimide layer, comprising: bonding a thermoplastic polyimide resin film or sheet obtained by melt extrusion of a thermoplastic polyimide resin or a biaxially oriented thermoplastic polyimide resin film or sheet to the metal foil or the conductor circuit layer by heating under pressure.

15. A method for manufacturing a flexible laminate, comprising: preparing copper foils of which at least one side has been subjected to a surface roughening treatment or an adhesion modification treatment, superposing a thermoplastic polyimide resin film or sheet obtained by melt extrusion of a thermoplastic polyimide resin or a biaxially oriented thermoplastic polyimide resin film or sheet on the treated side of said copper foil, superposing other copper foil on the opposite side of said film or sheet so that the treated side of said copper foil is brought into contact with said film or sheet, and heating them under pressure.

16. A method for manufacturing a flexible laminate, comprising: superposing thermoplastic polyimide resin films or sheets obtained by melt extrusion of a thermoplastic polyimide resin or biaxially oriented thermoplastic polyimide resin films or sheets on both sides of a polyimide resin film of which both sides have not been subjected to any surface treatment or have been subjected to an adhesion modification treatment, further superposing copper foils of which at least one side has been subjected to a surface roughening treatment or an adhesion modification treatment on outer opposite sides of said films or sheets in such a manner that the treated surface of each copper foil faces inward, and heating them under pressure.

17. A method for manufacturing a flexible laminate, comprising: sandwiching a thermoplastic polyimide resin film or sheet obtained by melt extrusion of a thermoplastic polyimide resin or a biaxially oriented thermoplastic polyimide resin film or sheet between double-sided flexible boards having circuits formed on both sides thereof which have not been subjected to any surface treatment or have been subjected to an adhesion modification treatment, and heating them under pressure.

18. A method for manufacturing a flexible laminate, comprising: superposing thermoplastic polyimide resin films or sheets obtained by melt extrusion of a thermoplastic polyimide resin or biaxially oriented thermoplastic polyimide resin films on outer opposite sides of a double-sided flexible board, respectively, which board has circuits formed on both sides thereof and has not been subjected to any surface treatment or has been subjected to an adhesion modification treatment, further superposing copper foils of which at least one side has been subjected to a surface roughening treatment or an adhesion modification treatment on outer opposite sides of said films or sheets in such a manner that the treated surface of each foil faces inward, and heating them under pressure.

19. The method according to claim 14, wherein said thermoplastic polyimide resin film or sheet or said biaxially oriented thermoplastic polyimide resin film or sheet has at least one surface subjected to a surface modification treatment.

20. The method according to claim 14, wherein said heating under pressure is performed at a temperature higher than a glass transition temperature Tg of the thermoplastic polyimide resin used.

21. The method according to claim 14, wherein said heating under pressure is performed at a temperature higher than a glass transition temperature Tg and lower than a melting point of the thermoplastic polyimide resin film used or of the biaxially oriented thermoplastic polyimide resin film used.

22. The method according to claim 14, wherein said heating under pressure is performed at a temperature in the range of 300-380° C.

23. The method according to claim 14, wherein a felt-like cushioning material is interposed between a press plate which is arranged in contact with a material to be heated under application of pressure and a pressing platen of a pressing machine at the time of said heating under pressure.

24. The method according to claim 14, wherein said felt-like cushioning material is made of an aromatic polyamide or polybenzoxazol.
